(19) United States
(12) Patent Application Publication
(10) Pub. No.: US 2003/0069887 A1
(43) Pub. Date: Apr. 10, 2003

(54) Schema-based services for identity-based access to inbox data

(76) Inventors: Mark H. Lucovsky, Sammamish, WA (US); Samuel J. George, San Mateo, CA (US); William R. Hoffman, Berkeley, CA (US); Jay C. Jacobs, Danville, CA (US); Paul A. Steckler, Redmond, WA (US)

Correspondence Address: MICHALIK & WYLIE PLLC, Suite 103, 14645 Bel-Red Road, Bellevue, WA, 98007, US

(21) Appl. No.: 10/021,563

(22) Filed: Oct. 22, 2001

Related U.S. Application Data
(60) Provisional application No. 60/275,809, filed on Mar. 14, 2001.

(51) Int. Cl. G06F 7/00

(52) U.S. Cl. 707/10

(57) ABSTRACT

A schema-based inbox service that provides Internet access to per-user inbox data, (e.g., name, address, telephone numbers and e-mail addresses), wherein access to the inbox data is based on each user's identity. The inbox service includes a schema that defines rules and a structure for each user's data, and also includes methods that provide access to the data in a defined way. The inbox schema thus corresponds to a logical document containing the data for each user. The user manipulates (e.g., reads or writes) data in the logical document by data access requests through defined methods. In one implementation, the inbox schemas are arranged as XML documents, and the services provide methods that control access to the data based on the requesting user's identification, defined role and scope for that role. In this way, data can be accessed by its owner, and shared to an extent determined by the owner. The structure of the data is defined from the perspective of the data, not from that of an application program or a device, whereby appropriate programs can communicate with the inbox service to access the data, with existing knowledge of the schema-defined format, regardless of the device or application program in use. Extensibility is defined into the schema.

### CROSS REFERENCE TO RELATED APPLICATIONS

The present application claims priority from co-pending U.S. provisional application serial No. 60/275,809, filed Mar. 14, 2001 and entitled “Identity-Based Service Communication Using XML Messaging Interfaces”, which is hereby incorporated herein by reference in its entirety. The present application is related to U.S. patent application Ser. No. ______ entitled Schema-Based Services for Identity-Based Data Access, filed concurrently herewith on Oct. 22, 2001.

### COPYRIGHT DISCLAIMER

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### FIELD OF THE INVENTION

The invention relates generally to computer network data access, and more particularly to systems, methods and data structures for accessing data and data-related services over a network.

### BACKGROUND OF THE INVENTION

There are many types of data that users need to manage and otherwise access. For example, users keep word processing documents, spreadsheet documents, calendars, telephone numbers and addresses, e-mail messages, financial information and so on. In general, users maintain this information on various personal computers, hand-held computers, pocket-sized computers, personal digital assistants, mobile phones and other electronic devices. In most cases, a user's data on one device is not accessible to another device, without some manual synchronization process or the like to exchange the data, which is cumbersome. Moreover, some devices do not readily allow for synchronization. For example, if a user leaves his cell phone at work, he has no way to get his stored phone numbers off the cell phone when at home, even if the user has a computing device or similar cell phone at his disposal. As is evident, these drawbacks result from the separate devices each containing their own data.

Corporate networks and the like can provide users with remote access to some of their data, but many users do not have access to such a network. For many of those that have access, connecting to a network with the many different types of devices, assuming such devices can even connect to a network, can be a complex or overwhelming problem.

Moreover, even if a user has centrally stored data, the user needs the correct type of device running the appropriate application program to access that data. For example, a user with a PDA that maintains a user's inbox (e.g., received and sent items and so on) with a simple email application program ordinarily will not be able to use that program to open inbox information stored by another application program or the like at work. In general, this is because the data is formatted and accessed according to the way the application program wants it to be formatted.

What is needed is a model wherein data is centrally stored for users, with a set of services that control access to the data with defined methods, regardless of the application program and/or device.

### SUMMARY OF THE INVENTION

Briefly, the present invention provides an inbox service for central (e.g., Internet) access to per-user contact data, based on each user's identity, wherein the Inbox service includes a schema that defines rules and a structure for the data, and also includes methods that provide access to the data in a defined way. Because the structure of the data is defined from the perspective of the data, not from that of an application program or a device, programs can communicate with the services to access the data, with existing knowledge of the format. In one implementation, the Inbox schemas are arranged as XML documents, and the services provide methods that control access to the data based on the requesting user's identification, defined role and scope for that role. In this way, data can be accessed by its owner, and shared to an extent determined by the owner. Extensibility is defined into the schema.

Other benefits and advantages will become apparent from the following detailed description when taken in conjunction with the drawings, in which:

### BRIEF DESCRIPTION OF THE DRAWINGS

FIG. 1 is a block diagram representing an exemplary computer system into which the present invention may be incorporated;

FIG. 2 is a block diagram representing a generic data access model in accordance with one aspect of the present invention;

FIG. 3 is a representation of services for identity-based data access in accordance with one aspect of the present invention; and

FIG. 4 is a block diagram representing a schema-based service for accessing data arranged in a logical content document based on a defined schema for that service in accordance with one aspect of the present invention.

### DETAILED DESCRIPTION

Exemplary Operating Environment

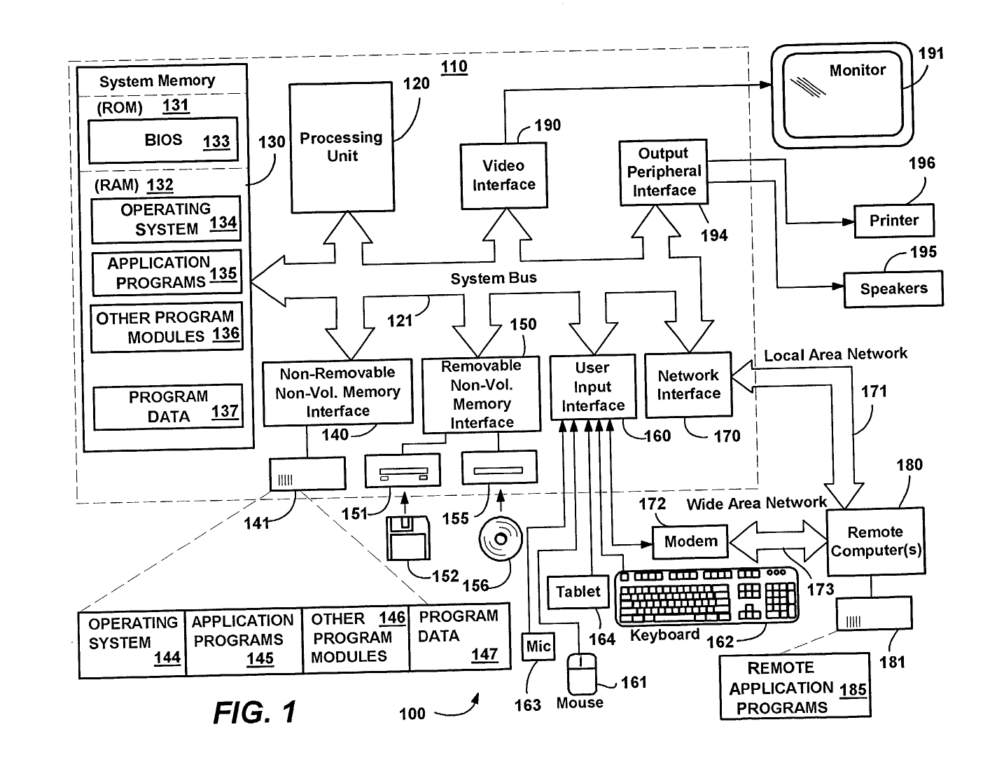

FIG. 1 illustrates an example of a suitable computing system environment 100 on which the invention may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention is operational with numerous other general purpose or special purpose computing system environments or configurations. Examples of well known computing systems, environments, and/or configurations that may be suitable for use with the invention include, but are not limited to: personal computers, server computers, hand-held or laptop devices, tablet devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, and so forth, that perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

With reference to FIG. 1, an exemplary system for implementing the invention includes a general purpose computing device in the form of a computer 110. Components of the computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 110 typically includes a variety of computer-readable media. Computer-readable media can be any available media that can be accessed by the computer 110 and includes both volatile and nonvolatile media, and removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer 110. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136 and program data 137.

The computer 110 may also include other removable/non-removable, volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media, discussed above and illustrated in FIG. 1, provide storage of computer-readable instructions, data structures, program modules and other data for the computer 110. In FIG. 1, for example, hard disk drive 141 is illustrated as storing operating system 144, application programs 145, other program modules 146 and program data 147. Note that these components can either be the same as or different from operating system 134, application programs 135, other program modules 136, and program data 137. Operating system 144, application programs 145, other program modules 146, and program data 147 are given different numbers herein to illustrate that, at a minimum, they are different copies. A user may enter commands and information into the computer 20 through input devices such as a tablet, or electronic digitizer, 164, a microphone 163, a keyboard 162 and pointing device 161, commonly referred to as mouse, trackball or touch pad. Other input devices not shown in FIG. 1 may include a joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. The monitor 191 may also be integrated with a touch-screen panel or the like. Note that the monitor and/or touch screen panel can be physically coupled to a housing in which the computing device 110 is incorporated, such as in a tablet-type personal computer. In addition, computers such as the computing device 110 may also include other peripheral output devices such as speakers 195 and printer 196, which may be connected through an output peripheral interface 194 or the like.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet. For example, in the present invention, the computer system 110 may comprise source machine from which data is being migrated, and the remote computer 180 may comprise the destination machine. Note however that source and destination machines need not be connected by a network or any other means, but instead, data may be migrated via any media capable of being written by the source platform and read by the destination platform or platforms.

When used in a LAN networking environment, the computer 110 is connected to the LAN 171 through a network interface or adapter 170. When used in a WAN networking environment, the computer 1 10 typically includes a modem 172 or other means for establishing communications over the WAN 173, such as the Internet. The modem 172, which may be internal or external, may be connected to the system bus 121 via the user input interface 160 or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

Data Access Model

The present invention generally operates in an architecture/platform that connects network-based (e.g., Internet-based) applications, devices and services, and transforms them into a user's personal network which works on the user's behalf, and with permissions granted by the user. To this end, the present invention is generally directed to schema-based services that maintain user, group, corporate or other entity data in a commonly accessible virtual location, such as the Internet. The present invention is intended to scale to millions of users, and be stored reliably, and thus it is likely that a user's data will be distributed among and/or replicated to numerous storage devices, such as controlled via a server federation. As such, while the present invention will be generally described with respect to an identity-centric model that enables a user with an appropriate identity and credentials to access data by communicating with various core or other services, it is understood that the schema-based services described herein are arranged for handling the data of millions of users, sorted on a per-user-identity basis. Note that while “user” is generally employed herein for simplicity, as used herein the term “user” is really a substitute for any identity, which may be a user, a group, another entity, an event, a project, and so on.

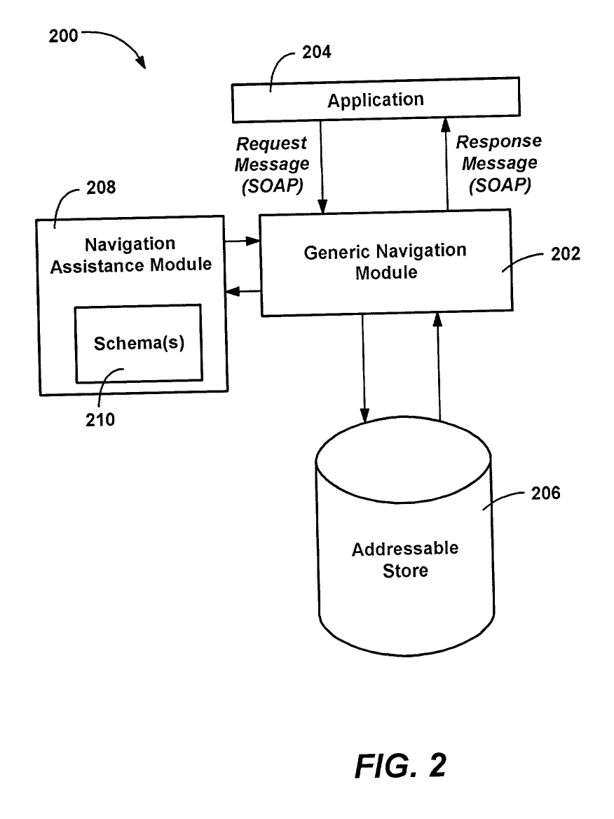

As generally represented in FIG. 2, a data access model 200 includes a generic navigation module 202 through which applications 204 and the like may access a wide variety of identity-based data, such as maintained in an addressable store 206. To access the data, a common set of command methods may be used to perform operations on various data structures that are constructed from the data in the addressable store 206, even though each of those data structures may represent different data and be organized quite differently. Such command methods may describe generic operations that may be desired on a wide variety of data structures, and include, for example, insert, delete, replace, update, query or changequery methods.

In accordance with one aspect of the present invention and as described in detail below, the data is accessed according to various schemas, with the schemas corresponding to identity-based services through which users access their data. As used herein, a “schema” generally comprises a set of rules that define how a data structure may be organized, e.g., what elements are supported, in what order they appear, how many times they appear, and so on. In addition, a schema may define, via color-coding or other identification mechanisms, what portions of an XML document (that corresponds to the data structure) may be operated on. Examples of such XML-based documents are described below. The schema may also define how the structure of the XML document may be extended to include elements not expressly mentioned in the schema.

As will be understood below, the schemas vary depending on the type of data they are intended to organize, e.g., an email-inbox-related schema organizes data differently from a schema that organizes a user's favorite websites. Further, the services that employ schemas may vary. As such, the generic navigation module 202 has associated therewith a navigation assistance module 208 that includes or is otherwise associated with one or more schemas 210. As will be understood, a navigation assistance module 208 as represented in FIG. 2 corresponds to one or more services, and possesses the information that defines how to navigate through the various data structures, and may also indicate which command methods may be executed on what portions of the data structure. Although in FIG. 2 only one navigation assistance module 208 is shown coupled to the generic navigation module 202, there may be multiple navigation assistance modules that may each specialize as desired. For example, each navigation assistance module may correspond to one service. Moreover, although the navigation assistance module 208 is illustrated as a separate module, some or all of the operations of the navigation assistance module 208 may be incorporated into the generic navigation module 202, and vice versa. In one embodiment, the various data structures constructed from the schema and addressable store data may comprise XML documents of various XML classes. In that case, the navigation assistance module 208 may contain a schema associated with each of the classes of XML documents.

The present invention provides a number of schema-based services that facilitate data access based on the identity of a user. Preferably, the user need not obtain a separate identity for each service, but rather obtains a single identity via a single set of credentials, such as with the Microsoft® Passport online service. With such an identity, a user can access data via these services from virtually any network connectable device capable of running an application that can call the methods of a service.

Services and Schemas

“.NET My Services” comprises identity-centric services which may be generally implemented in XML (extensible Markup Language) Message Interfaces (XMIs). While the present invention will be described with respect to XML and XMI, it can readily be appreciated that the present invention is not limited to any particular language or set of interfaces. The .NET My Services model essentially corresponds to one implementation of the generic data access model 200 of FIG. 2.

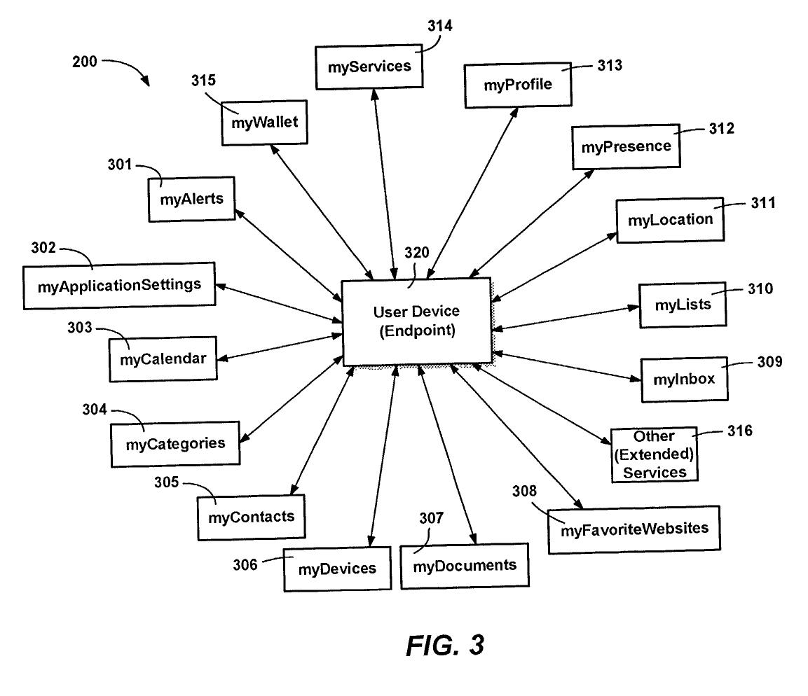

As generally represented in FIG. 3, .NET My Services 300 is implemented as a set of Web services 301-316, each bound to a .NET Identity (PUID, such as a Passport® unique identifier similar to a globally unique indentifier when Passport® is the authentication service). The services 301-316 can communicate with one another via a service-to-service communications protocol (SSCP), described below. As also described below, each service presents itself as a set of XML documents that can be manipulated from an application program 202 (FIG. 2) or the like using a set of standard methods and domain-specific methods. To this end, a user device 320 (endpoint) running such application programs connects a user's applications to the services, and the data controlled by those services, such as over the Internet or an Intranet, such as over the Internet or an Intranet. Note that endpoints can be client devices, applications or services. In keeping with the present invention, virtually any device capable of executing software and connecting to a network in any means may thus give a user access to data that the user is allowed to access, such as the user's own data, or data that a friend or colleague has specified as being accessible to that particular user.

In general, a .NET Identity is an identifier assigned to an individual, a group of individuals, or some form of organization or project. Using this identifier, services bound to that identity can be located and manipulated. A general effect is that each identity (e.g., of a user, group or organization) has tied to it a set of services that are partitioned along schema boundaries and across different identities. As will be understood, the L-document-centric architecture of .NET My Services provides a model for manipulating and communicating service state that is very different from prior data access models. The XML-document-centric approach, in conjunction with loose binding to the data exposed by the services, enables new classes of application programs. As will also be understood, the .NET My Services model 300 presents the various services 301-316 using a uniform and consistent service and method model, a uniform and consistent data access and manipulation model, and a uniform and consistent security authorization model.

In a preferred implementation, the .NET My Services model 300 is based upon open Internet standards. Services are accessed by means of SOAP (Simple Object Access Protocol) messages containing an XML payload. Service input and output is expressed as XML document outlines, and each of these document outlines conform to an XML schema document. The content is available to a user interacting with the .NET My Services service endpoint 320.

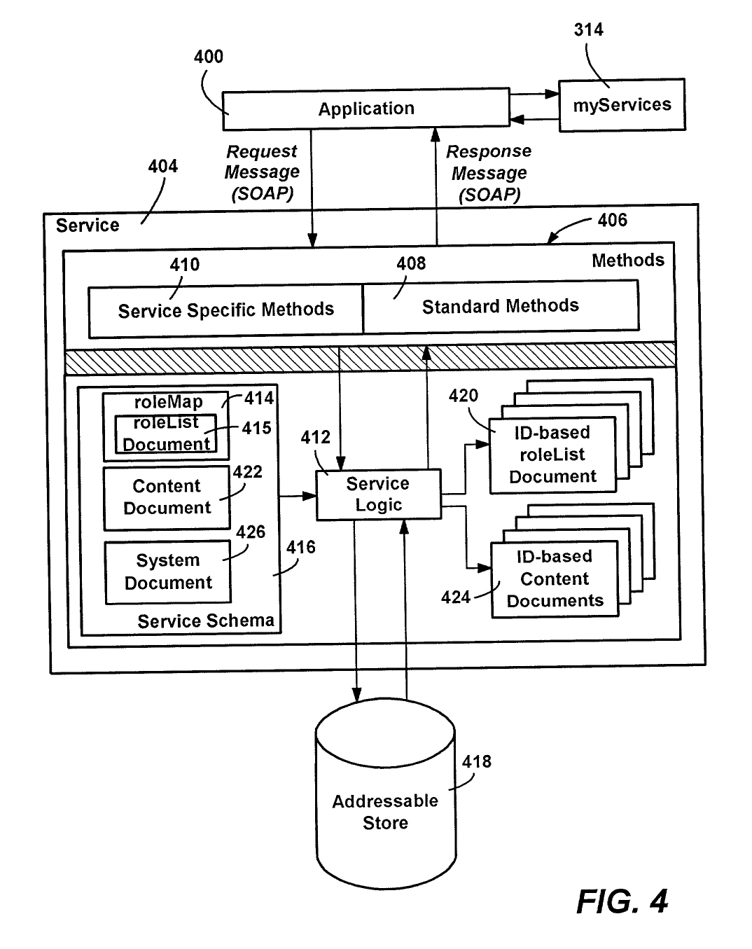

Turning to FIG. 4, in the .NET My Services model, an application 400 requests performance of a method that operates on data structures. The application may make a request that is generic with respect to the type of data structure being operated upon and without requiring dedicated executable code for manipulating data structures of any particular data type. To this end, the application first contacts a special myServices service 314 to obtain the information needed to communicate with a particular service 404, through a set of methods 406 of that service 404. For example, the needed information received from the myServices service 314 includes a URI of that service 404. Note that the service 404 may correspond to essentially any of the services represented in FIG. 3, such as the myInbox service 309.

The service 404 includes or is otherwise associated with a set of methods 406 including standard methods 408, such as to handle requests directed to insert, delete, replace, update, query or changequery operations on the data. The set of methods of a particular service may also include service specific methods 410. In general, the only way in which an application can communicate with a service are via that service's methods.

Each service includes service logic 412 for handling requests and providing suitable responses. To this end, the service logic performs various functions such as authorization, authentication, and signature validation, and further limits valid users to only the data which they are permitted to access. The security aspect of a service is not discussed herein, except to note that in general, for otherwise valid users, the user's identity determines whether a user can access data in a requested manner. To this end, a roleMap 414 comprising service-wide roleList document templates 415 and scopes (e.g., part of the overall service's schema 416), in conjunction with user-based data maintained in an addressable store 418, determines whether a particular requested method is allowed, e.g., by forming an identity-based roleList document 420. If a method is allowed, the scope information in the roleMap 414 determines a shape of data to return, e.g., how much content is allowed to be accessed for this particular user for this particular request. The content is obtained in accordance with a content document 422 in the service's schema 416 and the actual user data corresponding to that content document in the addressable store 418. In this manner, a per-identity shaped content document 424 is essentially constructed for returning to the user, or for updating the addressable store, as appropriate for the method. Note that FIG. 4 includes a number of ID-based roleList documents and ID-based content documents, to emphasize that the service 406 is arranged to serve multiple users. Also, in FIG. 4, a system document 426 is present as part of the schema 416, as described below.

Returning to FIG. 3, in one implementation, access to .NET My Services 300 is accomplished using SOAP messages formatted with .NET My Services-specific header and body content. Each of the .NET My Services will accept these messages by means of an HTTP POST operation, and generate a response by “piggy-backing” on the HTTP Response, or by issuing an HTTP POST to a .NET My Services response-processing endpoint 320. In addition to HTTP as the message transfer protocol, .NET My Services will support raw SOAP over TCP, a transfer protocol known as Direct Internet Message Encapsulation (or DIME). Other protocols for transferring messages are feasible.

Because .NET My Services are accessed by protocol, no particular client-side binding code, object models, API layers, or equivalents are required, and are thus optional. The .NET My Services will support Web Services Description Language (WSDL). It is not mandatory that applications wishing to interact with .NET My Services make use of any particular bindings, and such bindings are not described herein. Instead, the present invention will be generally described in terms of messages that flow between requesters of a particular service and the service endpoints. In order to interact with .NET My Services, a service needs to format a .NET My Services message and deliver that message to a .NET My Services endpoint. In order to format a message, a client needs to manipulate XML document outlines, and typically perform some simple, known (public-domain) cryptographic operations on portions of the message.

In accordance with one aspect of the present invention, and as described in FIG. 4 and below, in one preferred implementation, services (including the myInbox service 309) present three logical XML documents, a content document 422, roleList document 415 (of the roleMap 414), and a system document 426. These documents are addressable using .NET My Services message headers, and are manipulated using standard .NET My Services methods. In addition to these common methods, each service may include additional domain-specific methods, such as updateContactData.

Each .NET MyServices service thus logically includes a content document 422, which in general is the main, service-specific document. The schema for this document 422 is a function of the class of service, as will become apparent from the description of the myInbox service's content document below. For example, in the case of the myInbox service 309, the content document presents data in the shape dictated by the .NET My Services myInbox schema, whereas in the case of the “.NET FavoriteWebSites” service 308, the content document presents data in the shape dictated by a .NET myFavoriteWebSites schema.

Each service also includes a roleList document 415 that contains roleList information, comprising information that governs access to the data and methods exported by the service 404. The roleList document is manipulated using the .NET My Services standard data manipulation mechanisms. The shape of this document is governed by the .NET My Services core schema's roleListType XML data type.

Each service also includes a system document 426, which contains service-specific system data such as the roleMap, schemaMap, messageMap, version information, and service specific global data. The document is manipulated using the standard .NET data manipulation mechanism, although modifications are limited in a way that allows only the service itself to modify the document. The shape of this system document 426 may be governed by the system document schema for the particular service, in that each service may extend a base system document type with service specific information.

As is understood, the present invention is generally based on schemas, which in general comprise a set of rules or standards that define how a particular type of data can be structured. Via the schemas, the meaning of data, rather than just the data itself, may be communicated between computer systems. For example, a computer device may recognize that a data structure that follows a particular address schema represents an address, enabling the computer to “understand” the component part of an address. The computer device may then perform intelligent actions based on the understanding that the data structure represents an address. Such actions may include, for example, the presentation of an action menu to the user that represents things to do with addresses. Schemas may be stored locally on a device and/or globally in a federation's “mega-store.” A device can keep a locally-stored schema updated by subscribing to an event notification service (in this case, a schema update service) that automatically passes messages to the device when the schema is updated. Access to globally stored schemas is controlled by the security infrastructure.

General Schema Commonality

The .NET My Services data is defined using annotated XSD (extensible or XML Structure Definitions) schema files. The XSD files accurately type the data, but since XSD is a verbose and complex language, it is not a particularly efficient way to convey structure and meaning. Thus, for purposes of simplicity herein, the myInbox schemas are described below in terms of schema outlines with accompanying element/attribute descriptions. These document outlines accurately show the structure of the data contained within a service. However, because the present application is not viewable in color, the nodes, elements and/or attributes of the schema outlines (which may be described as bold blue, or blue), are represented in the schema outlines as boldface type. Those described as underlined red, or red, are represented as underlined type, while others referred to as black are represented in normal type.

The meaning of these bold (blue), underlined (red) and normal (black) items has significance with respect to the data model and to the data language that accesses and manipulates the data (e.g., via the insert, delete, replace, update, query, changequery or other methods). For example, each document described below contains a root element having an element name that matches that of the service, e.g., the myInbox service has a root element named myInbox. The .NET My Services name for this item is the root.

Documents contain elements that resemble first-class top-level objects, including, for example, <catDef/>, <myApplicationsSettings /> (other another name as appropriate) and <order/>. Such items are denoted in the outlines as bold (blue), and may be identified using an <xdb:blue/> tag. Bold (blue) items define major blocks of data within a service. These node sets are directly addressable by an identifier attribute, and their change status is tracked through a changeNumber attribute. Top-level bold blue items may be considered objects. As seen below, some bold (blue) objects contain nested bold blue objects. They usually contain frequently changing underlined (red) properties, which reduces the amount of synchronization traffic. Nested bold (blue) items may be considered property groups.

Each bold blue item contains one or more underlined (red) items which are elements or attributes. These items may be identified using the <xdb:red/> tag. These items are special in that they may be used within predicates (filters) to aid in xdb:bold blue selection. These items are also directly addressable and may be manipulated directly by the data manipulation language.

Each colored red element may contain one or more non-colorized elements and attributes, which are valid and semantically meaningful XML items in the service document. Such items are opaque to the data language. These uncolored (i.e., non-bold or underlined) elements and attributes may not be addressed directly, may not be selected in a node selection operation, and may not be used in a predicate node test. Note that if one of these items is in the path to an underlined red item, it may be used in a location step to the underlined red item, but may not be used as the selected node. Note that being opaque does not mean that the item is not considered during schema validation, but rather means that the item may not be used in a predicate, may not be directly addressed, and may not be inserted by itself As can be readily appreciated, in this manner, the .NET My Services thus limits the granularity of access to nodes within the service document, since only xdb:bold blue and xdb:underlined red marked items are directly addressable, and only those elements and attributes tagged with the xdb:underlined red annotation may be used in predicates to influence node selection. Using this technique, the .NET My Services storage system can efficiently manage indexes, increase the performance of node selection, partially shred the document data, and in general (because the node selections are well defined) fine-tune the node selection logic on a per-xdb:blue basis. The primary purpose of the xdb:blue is to define a base-level XML object that is designed to be operated on as a unit. The primary purpose of the xdb:red items is to aid in the selection of xdb:bold blues. The xdb:red items may be changed by the data language primitives so some level of fine-grained manipulation of the data is available, but only in very limited ways.

Bold blue items have unique IDs, which are usually assigned by .NET My Services, and are returned from update operations within the new blueId node. In all cases, the order of xxxBold blue follows the pre-order traversal of the document XML tree. Item IDs are UUIDs in the following format (h stands for a hexadecimal digit): hhhhhhhh-hhhh-hhhh-hhhh-hhhhhhhhhhhh.

In addition to identifiers, names and change numbers, nodes and especially red nodes may include creator identifiers, category information, and {any} fields. Category information enables data to be grouped and/or distinguished in some way, such as to share certain calendar information with golf buddies, send an email to immediately family, designate things such as which telephone number is the user's primary number, e.g., if a user has a second home, and so on. Fields of type “any” may comprise fully-typed, namespace-qualified fields that contain any type of content (e.g., free-form XML) therein. Such “any” fields thus allow extensibility of the schema, yet maintain the defined structure of a schema.

In one implementation, the core data-manipulation language implemented by the .NET My Services includes an insertRequest, or insert message. This primitive inserts any schema-valid XML fragment into a selected context, thereby changing the existing state of the document. A queryRequest, or message, retrieves data, such as to retrieve a document. Multiple queries may be specified in one request, and queries that select nothing are considered successful. It is possible to assert that the number of nodes in the selection falls in a given range. This is expressed using minOccurs and maxOccurs attributes. If a minOccurs/maxOccurs test fails on any node, the request is considered unsuccessful. Note that this is different from a failure code, which would be returned, for example, for a malformed request.

A deleteRequest primitive deletes the selected nodes and all their children. Note that, just like for other requests, attributes may be selected as well as elements. Empty selections result in successful operations, similar to Query. The minOccurs/maxOccurs tests are supported wherever select is allowed.

A replaceRequest primitive (replace message) is designed to replace the content of each of the selected nodes with the specified new content. Selected nodes themselves are not affected in any way. This may be considered as an atomic delete of the content of the selected node, followed by an insert. The content (text, attributes, elements) in the selected nodes are replaced with the new item specified in this message. The node type of the selected node and of the replacement node are thus required to be the same. The changequery request essentially returns result comrpising data that has changed.

As mentioned above, each of the services includes a RoleList document and scope information that describes which users have what type of access to which data. For example, a data owner will have read/write access to his or her own data, and can provide various types of rights to that data to other users based on their IDs, (e.g., read only to some users, read write to others). Each role list identifier may be associated with a scope, by which the kinds of data stored according to a given schema can be controlled per user. For example, a user can give a friend (with one identity) access via a service to a home telephone number, home address and so forth, but can give other users (with other identities) access only to a business telephone number. In general, a scope can be defined such that that it includes everything except any specifically listed items, or excludes everything except any specifically listed items.

myInbox

The.NET Inbox service, generally referred to as myInbox, is designed to store and manage e-mail related information for the associated identity. A primary purpose of the myInbox service is to supply this information, on demand, to applications operating on the identity's behalf Using this service, an identity can manage e-mail from a variety of devices, and even manage multiple accounts from the same application. It is expected that this service will support some form of subscription, or pending query, so that applications or services can reliably cache information contained within the service. An example of this caching might be an e-mail application or service. For each folder and message in the store, a subscription is issued against this service for that item. If the item changes, the application can refresh itself.

This myInbox service uses an XML schema to describe email, a user's email store, and the methods by which email is sent and received from the store. Throughout the following examples, an “hs” as in <hs: scope . . . > represents the namespace or schematic that may be used to interpret the corresponding element.

myInbox/Roles

The myInbox service controls access by using the rt0, rt2 and rt99 roleTemplates, using the following scopes:

scope allElements
<hs:scope id=7215df55-e4af-449f-a8e4-72a1f7c6a987>

<hs:shape base=t>
</hs:shape>

</hs:scope>
scope onlySelfElements
<hs:scope id=a159c93d-4010-4460-bc34-5094c49c1633>

<hs:shape base=nil>

<hs:include select=//*[@creator=‘$callerId’]/>

</hs:shape>

</hs:scope>
scope onlySelfSubscriptionElements
<hs:scope id=b7f05a6d-75cd-4958-9dfb-f532ebb17743>

<hs:shape base=nil>

<hs:include select=//subscription[@creator=‘$callerId’]/>

</hs:shape>

</hs:scope>
scope onlyPublicElements
<hs:scope id=da025540-a0c0-470f-adcf-9f07e5a5ec8f>

<hs:shape base=nil>

<hs:include select=//*[cat/@ref=‘hs:public’]/>
<hs:include select=//subscription[@creator=‘$callerId’]/>

</hs:shape>

</hs:scope>

The myInbox roleTemplate rt0 role gives complete read/write access to the information within the content document of the service being protected through this roleTemplate. The following table illustrates the available methods and the scope in effect when accessing the myInbox service through that method while mapped to this roleTemplate:

TABLE
myInbox roleTemplate rt0

| method | scope/name |
|---|---|
| Query | allElements |
| Insert | allElements |
| Replace | allElements |
| Delete | allElements |
| Update | allElements |
| sendMessage | allElements |
| saveMessage | allElements |
| copyMessage | allElements |

The myInbox roleTemplate rt2 role gives complete read access to the information within the content document of the service being protected through this roleTemplate. Applications mapping to this role have very limited write access and are only able to create and manipulate their own subscription nodes. The following table illustrates the available methods and the scope in effect when accessing the myInbox service through that method while mapped to this roleTemplate:

TABLE
myInbox roleTemplate rt2

| method | scope/name |
|---|---|
| Query | allElements |
| Insert | onlySelfSubscriptionElements |
| Replace | onlySelfSubscriptionElements |
| Delete | onlySelfSubscriptionElements |
| sendMessage | allElements |
| saveMessage | allElements |

The myInbox roleTemplate rt99 blocks access to the content document. Note that lack of a role in the roleList has the same effect as assigning someone to rt99.

myInbox/Content

The content document is an identity centric document, with its content and meaning a function of the user identifier (puid) used to address the service. Accessing the document is controlled by the associated roleList document. The following table comprises a schema outline that illustrates the layout and meaning of the information found in the content document for the myInbox service:

m:myInbox changeNumber=“...” instanceId=“...”

xmlns:m=“http://schemas.microsoft.com/hs/2001/10/myInbox”
xmlns:hs=“http://schemas.microsoft.com/hs/2001/10/core”>_{1 1}
<m:account changeNumber=“...” id=“...” creator=“...”>_{1 unbounded}

<m:name xml:lang=“...” dir=“...”>_{1 1}</m:name>
<m:email>_{1 1}</m:email>
<m:primary>_{1. 1}</m:primary>
<m:cat ref=“...”>_{0 unbounded}</m:cat>
<m:pop3Settings>_{0 1}

<m:server>_{1. 1}</m:server>
<m:userName>_{1 1}</m:userName>
<m:password>_{1. 1}</m:password>

</m:pop3Settings>
{any}

</m:account>
<m:folder changeNumber=“...” id=“...” creator=“...”>_{4 unbounded}

<m:name xml:lang=“...” dir=“...”>_{1 1}</m:name>
<m:type>_{1..1}</m:type>
<m:unread>_{0 1}</m:unread>
<m:parentFolder ref=“...”>_{0.1}</m:parentFolder>
<m:childFolderCount>_{0.1}</m:childFolderCount>
{any}

</m:folder>
<m:message changeNumber=“...” id=“...” creator=“...”>_{0. unbounded}

<m:messageStatus changeNumber=“...”>_{1..1}

<m:isRead>_{1.1}</m:isRead>
<m:folder ref=“...”>_{1..1}</m:folder>
<m:flag>_{0. 1}

<m:state>_{1..1}</m:state>
<m:title xml:lang=“...” dir=“...”>_{1 1}</m:title>
<m:reminderDate>_{0 1}</m:reminderDate>
{any}

</m:flag>
<m:state>_{1.1}</m:state>
{any}

</m:messageStatus>
<m:messageContent changeNumber=“...”>_{1 1}

<m:cat ref=“...”>_{0..unbounded}</m:cat>
<m:account ref=“...”>_{0 1}</m:account>
<m:messageType>_{1 1}

<m:type>_{1 1}</m:type>
<m:contentType>_{0.1}</m:contentType>
{any}

</m:messageType>
<m:size>_{1 1}</m:size>
<m:importance>_{1..1}</m:importance>
<m:sensitivity>_{1 1}</m:sensitivity>
<m:hasAttachments>_{1. 1}</m:hasAttachments>
<m:isJunkMail>_{1..1}</m:isJunkMail>
<m:containsAdultContent>_{1 1}</m:containsAdultContent>
<m:conversationId>_{0 1}</m:conversationId>
<m:conversationIndex>_{0 1}</m:conversationIndex>
<m:dateReceived>_{1..1}</m:dateReceived>
<m:dateSent>_{1 1}</m:dateSent>
<m:subject xml:lang=“...” dir=“...”>_{1 1}

<m:prefix>_{1 1}</m:prefix>
<m:text>_{1 1}</m:text>

</m:subject>
<m:from>_{1.1}

<m:name xml:lang=“...” dir=“...”>_{1.1}</m:name>
<m:email>_{1 1}</m:email>

</m:from>
<m:recipient type=“...”>_{0. unbounded}

<m:name xml:lang=“...” dir=“...”>_{1 1}</m:name>
<m:email>_{1.1}</m:email>

</m:recipient>
<m:plainBody>_{0..1}</m:plainBody>
<m:htmlBody>_{0..1}

<m:body>_{1 1}</m:body>
<m:inlineAttachment>_{0 unbounded}

<m:uri>_{1.1}</m:uri>
<m:contentType>_{1.1}</m:contentType>
<m:content>_{1 1}</m:content>

</m:inlineAttachment>

</m:htmlBody>
<m:attachment>_{0. unbounded}

<m:name>_{1. 1}</m:name>
<m:ord>_{1.1}</m:ord>
<m:contentType>_{1 1}</m:contentType>
<m:content>_{1..1}</m:content>

</m:attachment>
<m:messagePart id=“...”>_{0 unbounded}

<m:parentPart ref=“...”>_{1..1}</m:parentPart>
<m:order>_{1 1}</m:order>
<m:contentType>_{1..1}</m:contentType>
<m:size>_{1..1}</m:size>
<m:contentDisposition>_{0 1}</m:contentDisposition>
<m:contentId>_{0 1}</m:contentId>
<m:contentLocation>_{0 1}</m:contentLocation>
<m:contentTransferEncoding>_{0 1}</m:contentTransferEncoding>
<m:partContent>_{0 1}</m:partContent>

</m:messagePart>
<m:preview xml:lang=“...” dir=“...”>_{0 1}</m:preview>
<m:single2822Header>_{0 unbounded}</m:single2822Header>
<m:raw2822Content>_{0 1}</m:raw2822Content>
<m:raw2822Headers>_{0 1}</m:raw2822Headers>
{any}

</m:messageContent>

</m:message>
<m:draft changeNumber=“...” id=“...” creator=“...”>_{0 unbounded}

<m:draftStatus changeNumber=“...”>_{1 1}

<m:isRead>_{1 1}</m:isRead>
<m:folder ref=“...”>_{1 1}</m:folder>
<m:flag>_{0. 1}

<m:state>_{1. 1}</m:state>
<m:title xml:lang=“...” dir=“...”>_{1.1}</m:title>
<m:reminderDate>_{0 1}</m:reminderDate>
{any}

</m:flag>
<m:state>_{1 1}</m:state>
{any}

</m:draftStatus>
<m:draftContent changeNumber=“...”>_{1 1}

<m:cat ref=“...”>_{0..unbounded}</m:cat>
<m:account ref=“...”>_{1 1}</m:account>
<m:draftType>_{1..1}

<m:type>_{1 1}</m:type>
<m:contentType>_{0..1}</m:contentType>
{any}

</m:draftType>
<m:size>_{1..1}</m:size>
<m:importance>_{1 1}</m:importance>
<m:sensitivity>_{1..1}</m:sensitivity>
<m:hasAttachments>_{1..1}</m:hasAttachments>
<m:conversationId>_{0 1}</m:conversationId>
<m:conversationIndex>_{0. 1}</m:conversationIndex>
<m:subject xml:lang=“...” dir=“...”>_{1 1}

<m:prefix>_{1 1}</m:prefix>
<m:text>_{1. 1}</m:text>

</m:subject>
<m:from>_{1..1}

<m:name xml:lang=“...” dir=“...”>_{1. 1}</m:name>
<m:email>_{1 1}</m:email>

</m:from>
<m:recipient type=“...”>_{0 .unbounded}

<m:name xml:lang=“...” dir=“...”>_{1 1}</m:name>
<m:email>_{1 1}</m:email>

</m:recipient>
<m:plainBody>_{0. 1}</m:plainBody>
<m:htmlBody>_{0.1}

<m:body>_{1..1}</m:body>
<m:inlineAttachment>_{0 unbounded}

<m:uri>_{1..1}</m:uri>
<m:contentType>_{1..1}</m:contentType>
<m:content>_{1 1}</m:content>

</m:inlineAttachment>

</m:htmlBody>
<m:attachment>_{0 .unbounded}

<m:name>_{1..1}</m:name>
<m:ord>_{1 1}</m:ord>
<m:contentType>_{1..1}</m:contentType>
<m:content>_{1. 1}</m:content>

</m:attachment>
<m:draftPart changeNumber=“...”>_{1 unbounded}

<m:parentPart ref=“...”>_{1 1}</m:parentPart>
<m:order>_{1 1}</m:order>
<m:contentType>_{1..1}</m:contentType>
<m:size>_{1..1}</m:size>
<m:contentDisposition>_{0 1}</m:contentDisposition>
<m:contentId>_{0 1}</m:contentId>
<m:contentLocation>_{0. 1}</m:contentLocation>
<m:contentTransferEncoding>_{0 1}</m:contentTransferEncoding>
<m:partContent>_{1. 1}</m:partContent>
{any}

</m:draftPart>
<m:preview xml:lang=“...” dir=“...”>_{0.1}</m:preview>
<m:single2822Header>_{0 .unbounded}</m:single2822Header>
<m:raw2822Content>_{0..1}</m:raw2822Content>
<m:raw2822Headers>_{0..1}</m:raw2822Headers>
{any}

</m:draftContent>
{any}

</m:draft>
<m:rule sequence=“...” changeNumber=“...” id=“...” creator=“...”>_{0 unbounded}

<mname xml:lang=“...” dir=“...”>_{1 1}</m:name>
<m:state>_{1 1}</m:state>
<m:runat>_{1..1}</m:runat>
<m:runwhen>_{1..1}</m:runwhen>
<m:type>_{1..1}</m:type>
<m:provider xml:lang=“...” dir=“...”>_{1 1}</m:provider>
<m:condition select=“...”>_{1 1}</m:condition>
<m:action sequence=“...”>_{1. unbounded}

<m:copyMessage>_{0. 1}

<m:targetFolder select=“...”>_{1 1}</m:targetFolder>

</m:copyMessage>
<m:moveMessage>_{0.1}

<m:targetFolder select=“...”>_{1. 1}</m:targetFolder>

</m:moveMessage>
<m:deleteMessage>_{0 1}</m:deleteMessage>
<m:assignCategory>_{0 1}

<m:cat ref=“...”>_{0 unbounded}</m:cat>

</m:assignCategory>
<m:forwardMessage>_{0 1}

<m:recipient type=“...”>_{0 unbounded}

<m:name xml:lang=“...” dir=“...”>_{1. 1}</m:name>
<m:email>_{1 1}</m:email>

</m:recipient>

</m:forwardMessage>
<m:forwardAsAttachment>_{0 1}

<m:recipient type=“...”>_{0 unbounded}

<m:name xml:lang=“...” dir=“...”>_{1 1}</m:name>
<m:email>_{1 1}</m:email>

</m:recipient>

</m:forwardAsAttachment>
<m:serverReply>_{0. 1}

<m:subject xml:lang=“...” dir=“...”>_{1 1}

<m:prefix>_{1..1}</m:prefix>
<m:text>_{1.1}</m:text>

</m:subject>
<m:simpleBody xml:lang=“...” dir=“...”>_{1.1}</m:simpleBody>

</m:serverReply>
<m:redirectMessage>_{0.1}

<m:recipient type=“...”>_{0 unbounded}

<m:name xml:lang=“...” dir=“...”>_{1 1}</m:name>
<m:email>_{1. 1}</m:email>

</m:recipient>

</m:redirectMessage>
<m:flagMessage>_{0 1}

<m:flag>_{1..1}

<m:state>_{1 1}</m:state>
<m:title xml:lang=“...” dir=“...”>_{1..1}</m:title>
<m:reminderDate>_{0 1}</m:reminderDate>
{any}

</m:flag>

</m:flagMessage>
<m:markAsRead>_{0..1}</m:markAsRead>
<m:stopProcessingRulesOfThisType>_{0 1}</m:stopProcessingRulesOfThisType>

</m:action>
{any}

</m:rule>
<m:subscription changeNumber=“...” id=“...” creator=“...”>_{0 unbounded}

<hs:trigger select=“...” mode=“...” baseChangeNumber=“...”>_{1 1}</hs:trigger>
<hs:expiresAt>_{0 1}</hs:expiresAt>
<hs:context uri=“...”>_{1. 1} {any}</hs:context>
<hs:to>_{1 1}</hs:to>

</m:subscription>
{any}

</m:myInbox>

The meaning of the attributes and elements shown in the table are set forth below, wherein in the syntax used in the table, boldface type corresponds to a blue node, and underlined type to a red node, as described above, and the minimum occurrence information (0, 1) indicates whether an element or attribute is required or optional, and maximum occurrence information (1, unbounded) indicates whether one or many are possible.

The /myInbox (minOccurs=1 maxOccurs=1) element represents the root element of myInbox. The /myInbox/@changeNumber (minOccurs=1 maxOccurs=1) changeNumber attribute is designed to facilitate caching of the element and its descendants. This attribute is assigned to this element by the .NET My Services system. The attribute is read only to applications. Attempts to write this attribute are silently ignored.

The /myInbox/@instanceId (string minOccurs=0 maxOccurs=1) attribute is a unique identifier typically assigned to the root element of a service. It is a read-only element and assigned by the .NET My Services system when a particular service is provisioned for a user. The /myInbox/account (minOccurs=1 maxOccurs=unbounded) element represents a provisioned user's email account. This element can optionally contain POP3 settings for myInbox services that support POP3 aggregation.

The /myInbox/account/@changeNumber (minOccurs=1 maxOccurs=1) changeNumber attribute is designed to facilitate caching of the element and its descendants. This attribute is assigned to this element by the .NET My Services system. The attribute is read only to applications. Attempts to write this attribute are silently ignored.

The /myInbox/account/@id (minOccurs=1 maxOccurs=1) attribute is a globally unique ID assigned to this element by .NET My Services. Normally, .NET My Services generates and assigns this ID during an insertRequest operation or possibly during a replaceRequest. Application software can override this ID generation by specifying the useClientIds attribute in the request message. After an ID has been assigned, the attribute is read only and attempts to write it are silently ignored.

The /myInbox/account/@creator (minOccurs=1 maxOccurs=1) attribute identifies the creator in terms of userId, appId, and platformId of the node.

The /myInbox/account/name (string minOccurs=1 maxOccurs=1) field maintains the display name of the account. The /myInbox/account/name/@xml:lang (minOccurs=1 maxOccurs=1) required attribute is used to specify an ISO 639 language code or an ISO 3166 country code as described in RFC 1766 (wherein ISO stands for International Organization for Standardization and RFC stands for Request For Comment). The value of this attribute indicates the language type of the content within this element. The /myInbox/account/name/@dir (string minOccurs=0 maxOccurs=1) optional attribute specifies the default layout direction for the localized string. Valid values are rtl (right to left) and ltr (left to right).

The /myInbox/account/email (string minOccurs=1 maxOccurs=1) field maintains the SMTP email account.

The /myInbox/account/primary (boolean minOccurs=1 maxOccurs=1) element defines this account as a primary or non-primary account. There can be only one primary account, and it can never be deleted.

The /myInbox/account/cat/@ref (anyURI minOccurs=1 maxOccurs=1) attribute references a category definition (catDef) element using the rules outlined in the .NET Categories section (myCategories) described above.

The /myInbox/account/pop3 Settings (minOccurs=0 maxOccurs=1) defines pop3 settings, if this account is a POP3 account. Note that the primary account can not be a POP3 account. The /myInbox/account/pop3Settings/server (string minOccurs=1 maxOccurs=1) field contains the name of the POP3 server. The /myInbox/account/pop3 Settings/userName (string minOccurs=1 maxOccurs=1) contains the username of the POP3 account. The /myInbox/account/pop3Settings/password (string minOccurs=1 maxOccurs=1) contains the password of the POP3 account.

Like other unbounded elements, multiple accounts may be set up, providing significantly functionality. For example, one node may maintain a user's primary email account, with another node set up as a secondary account. Even though email is received on one account, e.g., a POP3 account, it can be sent out on the other, e.g., an office email account.

The /myInbox/account/{any} (minOccurs=0 maxOccurs=unbounded) field allows for extensibility.

Folders represent the unit of containment for the myInbox service. The /myInbox/folder (minOccurs=4 maxOccurs=unbounded) folder element in myInbox are containers for messages, although not directly. Messages are related to folders via the /myInbox/message/messageStatus/folder ref=“” attribute. Folders can be organized hierarchically, although again not directly. Instead, folder containment is modeled using the /myInbox/folder/parentFolder ref×“” attribute. If a folder is deleted, all associated messages, folders and their messages are deleted. It is recommended that instead of deleting a folder directly, it should be moved to the type=“deleted” folder first. There are four built in types of folders, and these can be identified by four special type element values: /folder/type =‘inbox’ is the Inbox folder. /folder/type=‘sent’ is the Sent Items folder. /folder/type=‘drafts’ is the Drafts folder. /folder/type=‘deleted’ is the Deleted Items folder. These four special folders will always exist in a provisioned .NET Inbox account, and cannot be deleted or modified. To create user defined folders, the standard .NET My Services insert method can be used, with the type set to ‘custom’. Custom (user-defined) folders can be created, deleted or modified, and virtual hierarchies can be established via the parent folder attribute.

The /myInbox/folder/@changeNumber (minOccurs=1 maxOccurs=1) changeNumber attribute is designed to facilitate caching of the element and its descendants. This attribute is assigned to this element by the .NET My Services system. The attribute is read only to applications. Attempts to write this attribute are silently ignored.

The /myInbox/folder/@id (minOccurs=1 maxOccurs=1) attribute is a globally unique ID assigned to this element by .NET My Services. Normally, .NET My Services generates and assigns this ID during an insertRequest operation or possibly during a replaceRequest. Application software can override this ID generation by specifying the useClientIds attribute in the request message. After an ID has been assigned, the attribute is read only and attempts to write it are silently ignored.

The /myInbox/folder/@creator (minOccurs=1 maxOccurs=1) attribute identifies the creator in terms of userId, appId, and platformId of the node. The /myInbox/folder/name (string minOccurs=1 maxOccurs=1) element contains the name of the e-mail folder. For the four special folders, this element is read only. For custom folders, this element can be edited. The /myInbox/folder/name/@xml:lang (minOccurs=1 maxOccurs=1) required attribute is used to specify an ISO 639 language code or an ISO 3166 country code as described in RFC 1766. The value of this attribute indicates the language type of the content within this element. The /myInbox/folder/name/@dir (string minOccurs=0 maxOccurs=1) optional attribute specifies the default layout direction for the localized string. Valid values are rtl (right to left) and ltr (left to right).

The /myInbox/folder/type (string minOccurs=1 maxOccurs=1) element contains a type identifier for this folder, and will contain the value ‘inbox’, ‘sent’, ‘drafts’ or ‘delete’ for the four special folders. For other folders, this value will be ‘custom’.

The /myInbox/folder/unread (unsignedLong minOccurs=0 maxOccurs=1) contains the calculated count of the unread messages associated with this folder. This element is read only. The /myInbox/folder/parentFolder (minOccurs=0 maxOccurs=1) element contains a ref attribute that specifies the ID of the parent folder. For top-level folders, this attribute ==“”. This attribute cannot be set on the four special folders, as they remain top level folders.

The /myInbox/folder/parentFolder/@ref (minOccurs=0 maxOccurs=1) contains a uuidType used to specify a universally unique identifier (UUID).

The /myInbox/folder/childFolderCount (unsignedLong minOccurs=0 maxOccurs=1) attribute is calculated by the service, and indicates how many subfolders that folder contains. Note that fields can be calculated rather than stored or changed by the user. For example, a calculated field is used to maintain information such as how many items are in a folder since this number is not something a user directly decides, but rather results from other information.

The /myInbox/folder/{any} (minOccurs=0 maxOccurs=unbounded) field allows for extensibility.

The /myInbox/message (minOccurs=0 maxOccurs=unbounded) element defines a single message in myInbox in the base schema. A message represents an email message, and is divided into two sub-groups ‘messageStatus’ and ‘messageContent’. This field is for received and sent messages, (not for drafts).

The /myInbox/message/@changeNumber (minOccurs=1 maxOccurs=1) changeNumber attribute is designed to facilitate caching of the element and its descendants. This attribute is assigned to this element by the .NET My Services system. The attribute is read only to applications. Attempts to write this attribute are silently ignored.

The /myInbox/message/@id (minOccurs=1 maxOccurs=1) attribute is a globally unique ID assigned to this element by .NET My Services. Normally, .NET My Services generates and assigns this ID during an insertRequest operation or possibly during a replaceRequest. Application software can override this ID generation by specifying the useClientIds attribute in the request message. After an ID has been assigned, the attribute is read only and attempts to write it are silently ignored.

The /myInbox/message/@creator (minOccurs=1 maxOccurs=1) attribute identifies the creator in terms of userId, appId, and platformId of the node. The /myInbox/message/messageStatus (minOccurs=1 maxOccurs=1) element defines the status of the email, and frequently changes. Caching clients should take advantage of this when deciding which part of the message to change.

The /myInbox/message/messageStatus/@changeNumber (minOccurs=1 maxOccurs=1) changeNumber attribute is designed to facilitate caching of the element and its descendants. This attribute is assigned to this element by the .NET My Services system. The attribute is read only to applications. Attempts to write this attribute are silently ignored.

Certain email-related elements frequently change. If a user wants to synchronize on each change, a great deal of information would need to be exchanged, even though most changes are simple changes in message status, rather than content, such as from unread to read. Status information is thus maintained separately. The /myInbox/message/messageStatus/isRead (boolean minOccurs=1 maxOccurs=1) element defines the read/unread state of the message, and can be modified. The /myInbox/message/messageStatus/folder (minOccurs=1 maxOccurs=1) element defines the single folder to which this message logically belongs. The /myInbox/message/messageStatus/folder/@ref (minOccurs=0 maxOccurs=1) uuidType is used to specify a universally unique identifier (UUID).

The /myInbox/message/messageStatus/flag (minOccurs=0 maxOccurs=1) optional element defines the flag state of the message. It includes an {any} element that can be used for extensible flags. The /myInbox/message/messageStatus/flag/state (string minOccurs=1 maxOccurs=1) field maintains state of a message flag. The /myInbox/message/messageStatus/flag/title (string minOccurs=1 maxOccurs=1) field maintains the client-defined text of the flag. The /myInbox/message/messageStatus/flag/title/@xml:lang (minOccurs=1 maxOccurs=1) required attribute is used to specify an ISO 639 language code or an ISO 3166 country code as described in RFC 1766. The value of this attribute indicates the language type of the content within this element. The /myInbox/message/messageStatus/flag/title/@dir (string minOccurs=0 maxOccurs=1) optional attribute specifies the default layout direction for the localized string. Valid values are rtl (right to left) and ltr (left to right).

The /myInbox/message/messageStatus/flag/reminderDate (dateTime minOccurs=0 maxOccurs=1) field maintains the client-defined reminder date of the flag. The /myInbox/message/messageStatus/flag/{any} (minOccurs=0 maxOccurs=unbounded) field allows for extensibility.

The /myInbox/message/messageStatus/state (string minOccurs=1 maxOccurs=1) element defines the sent/received state of the message. This element is read only, which means that it can be queried for, but not updated. The /myInbox/message/messageStatus/{any} (minOccurs=0 maxOccurs=unbounded) field allows for extensibility.

The /myInbox/message/messageContent (minOccurs=1 maxOccurs=1) element defines the content of the message. This data changes rarely in a normal application.

The /myInbox/message/messageContent/@changeNumber (minOccurs=1 maxOccurs=1) changeNumber attribute is designed to facilitate caching of the element and its descendants. This attribute is assigned to this element by the .NET My Services system. The attribute is read only to applications. Attempts to write this attribute are silently ignored.

The /myInbox/message/messageContent/cat (minOccurs=0 maxOccurs=unbounded) element is used to categorize the element that contains it by referencing either a global category definition (in either the .NET Categories service system document or an external resource containing category definitions), or by referencing an identity-centered category definition in the content document of the .NET Categories service for a particular PUID.

The /myInbox/message/messageContent/cat/@ref (anyURI minOccurs=1 maxOccurs=1) attribute references a category definition (catDef) element using the rules outlined in the .NET Categories section (myCategories) described above.

The /myInbox/message/messageContent/account (minOccurs=0 maxOccurs=1) element contains a reference to the /myInbox/account element to which this message was sent.

The /myInbox/message/messageContent/account/@ref (minOccurs=0 maxOccurs=1) uuidType is used to specify a universally unique identifier (UUID).

The /myInbox/message/messageContent/messageType (minOccurs-1 maxOccurs=1) subelements of this element describe the contents of the message.

The /myInbox/message/messageContent/messageType/type (string minOccurs=1 maxOccurs=1) element contains a value that provides the client with enough information to render an ‘Inbox’ view of the messages. Valid values include ‘voice’, ‘subscription’, ‘fax’, ‘dsn’, ‘readReceipt’, ‘meetingResponse’, ‘meetingRequest’, ‘email’ or ‘liveEmail’.

The /myInbox/message/messageContent/messageType/contentType (string minOccurs=0 maxOccurs=1) field maintains the contentType of the message (in accordance with RFC 2045). Examples of this are: ‘text/plain’ and ‘multipart/mime’.

The /myInbox/message/messageContent/messageType/{any} (minOccurs=0 maxOccurs=unbounded) field allows for extensibility.

The /myInbox/message/messageContent/size (unsignedLong minOccurs=1 maxOccurs=1) element contains the size, in bytes, of the entire RFC2822 message in the store.

The /myInbox/message/messageContent/importance (string minOccurs=1 maxOccurs=1) element indicates the importance of this message. Valid values include ‘low’, ‘normal’, or ‘high’. The default is ‘normal’.

The /myInbox/message/messageContent/sensitivity (string minOccurs=maxOccurs=1) element indicates the sensitivity of the message. Valid values include ‘normal’, ‘personal’, ‘private’, or ‘confidential’.

The /myInbox/message/messageContent/hasAttachments (boolean minOccurs=1 maxOccurs=1) element indicates whether a message has one or more attachments. The value will either be 0 (to indicate that the message has no attachments) or 1 (to indicate that the message has one or more attachments).

The /myInbox/message/messageContent/isJunkMail (boolean minOccurs=1 maxOccurs=1) element is read only and is set by the myInbox service when the message was delivered, and indicates if the message was marked as junk mail by the junk mail filter.

The /myInbox/message/messageContent/containsAdultContent (boolean minOccurs=1 maxOccurs=1) read-only element is set by the myInbox service when the message was delivered and indicates if the message was determined to contain adult content by the adult content mail filter.

The /myInbox/message/messageContent/conversationId (string minOccurs=0 maxOccurs=1) optional element identifies the ‘conversation,’ or e-mail thread of which this message is a part.

The /myInbox/message/messageContent/conversationIndex (string minOccurs=0 maxOccurs=1) optional element identifies the ‘conversation,’ or e-mail thread of which this message is a part.

The /myInbox/message/messageContent/dateReceived (dateTime minOccurs=1 maxOccurs=1) read-only element contains the UTC date/time the message was received, and appears in all messages except ones that were sent by the user.

The /myInbox/message/messageContent/dateSent (dateTime minOccurs=1 maxOccurs=1) read-only element contains the UTC date/time the message was sent. For /message/messageStatus/state=“sent” messages, this element represents the time the message was sent. For /message/messageStatus/state=“received” this element represents the time the sender sent the message.

The /myInbox/message/messageContent/subject (minOccurs=1 maxOccurs=1) element contains the subject of the message. This element contains both a prefix and text sub-elements, to allow clients to sort on the non-prefix part of the subject (e.g., so RE: RE: doesn't get sorted). The /myInbox/message/messageContent/subject/@xml:lang (minOccurs=1 maxOccurs=1) required attribute is used to specify an ISO 639 language code or an ISO 3166 country code as described in RFC 1766. The value of this attribute indicates the language type of the content within this element. The /myInbox/message/messageContent/subject/@dir (string minOccurs=0 maxOccurs=1) optional attribute specifies the default layout direction for the localized string. Valid values are rtl (right to left), and ltr (left to right).

The /myInbox/message/messageContent/subject/prefix (string minOccurs=1 maxOccurs=1) contains the prefix of a message subject, (e.g., ‘FW:’).

The /myInbox/message/messageContent/subject/text (string minOccurs=1 maxOccurs=1) contains the subject of a message minus the prefix (e.g., ‘hello there’).

The /myInbox/message/messageContent/from (minOccurs=1 maxOccurs=1) is a read-only element that describes who this message is from.

The /myInbox/message/messageContent/from/name (string minOccurs=1 maxOccurs=1) field includes the display name of an e-mail address. The /myInbox/message/messageContent/from/name/@xml:lang (minOccurs=1 maxOccurs=1) required attribute is used to specify an ISO 639 language code or an ISO 3166 country code as described in RFC 1766. The value of this attribute indicates the language type of the content within this element. The /myInbox/message/messageContent/from/name/@dir (string minOccurs=0 maxOccurs=1) optional attribute specifies the default layout direction for the localized string. Valid values are rtl (right to left) and ltr (left to right).

The /myInbox/message/messageContent/from/email (string minOccurs=1 maxOccurs=1) field maintains an e-mail address (for example, someone@microsoft.com).

The /myInbox/message/messageContent/recipient (minOccurs=0 maxOccurs=unbounded) field specifies the recipient of this message and where they appear. A collection of recipient elements is only returned if the query option ‘expandRecipients’ is specified.

The /myInbox/message/messageContent/recipient/@type (string minOccurs=1 maxOccurs=1) field specifies whether the recipient is in the ‘to’ or ‘cc’ list.

The /myInbox/message/messageContent/recipient/name (string minOccurs=1 maxOccurs=1) stores the display name of the recipient's e-mail address. The /myInbox/message/messageContent/recipient/name/@xml: lang (minOccurs=1 maxOccurs=1) required attribute is used to specify an ISO 639 language code or an ISO 3166 country code as described in RFC 1766. The value of this attribute indicates the language type of the content within this element. The /myInbox/message/messageContent/recipient/name/@dir (string minOccurs=0 maxOccurs=1) optional attribute specifies the default layout direction for the localized string. Valid values are rtl (right to left) and ltr (left to right).

The /myInbox/message/messageContent/recipient/email (string minOccurs=1 maxOccurs=1) field contains an e-mail address (for example, someone@microsoft.com).

The /myInbox/message/messageContent/plainBody (string minOccurs=0 maxOccurs=1) field contains the plain body representation of the message. This element is returned by passing the ‘includeSimpleMessageView’ element in query options.

The /myInbox/message/messageContent/htmlBody (minOccurs=0 maxOccurs=1) field contains the html body representation of the message. This element can also contain inline attachments that are related to the html content via the ‘uri’ element of the inline attachment. This element is returned by passing the ‘includeSimpleMessageView’ element in query options. The /myInbox/message/messageContent/htmlBody/body (string minOccurs=1 maxOccurs=1) field contains the contents of the body.

The /myInbox/message/messageContent/htmlBody/inlineAttachment (minOccurs=0 maxOccurs=unbounded) element represents an inline attachment The /myInbox/message/messageContent/htmlBody/inlineAttachment/uri (string minOccurs=1 maxOccurs=1) field contains the client-defined unique identifier for the inline attachment. This element is used to identify this attachment location within the html body of a message.

The /myInbox/message/messageContent/htmlBody/inlineAttachment/contentType (string minOccurs=1 maxOccurs=1) field contains the Content-Type of the attachment.

The /myInbox/message/messageContent/htmlBody/inlineAttachment/content (base64Binary minOccurs=1 maxOccurs=1) field contains the base64 encoded attachment content.

The /myInbox/message/messageContent/attachment (minOccurs=0 maxOccurs=unbounded) element represents a mail attachment and is returned by passing the ‘includeSimpleMessageViewAttachments’ element in query options.

The /myInbox/message/messageContent/attachment/name (string minOccurs=1 maxOccurs=1) field contains the client defined name of the attachment.

The /myInbox/message/messageContent/attachment/ord (unsignedLong minOccurs=1 maxOccurs=1) field contains the unique order that this attachment should appear relative to all other attachments.

The /myInbox/message/messageContent/attachment/contentType (string minOccurs=1 maxOccurs=1) field contains the Content-Type of the attachment.

The /myInbox/message/messageContent/attachment/content (base64Binary minOccurs=1 maxOccurs=1) field contains the base64 encoded attachment content.

The /myInbox/message/messageContent/messagePart (minOccurs=0 maxOccurs=unbounded) field contains the element and its children define the message structure (including the mime body). This element is returned by passing the ‘includeMessagePartStructure’ element in query options.

The /myInbox/message/messageContent/messagePart/@id (minOccurs=1 maxOccurs=1) field contains the unique identifier of the messagePart. The /myInbox/message/messageContent/messagePart/parentPart (minOccurs=1 maxOccurs=1) element points to the parent part of this part. The /myInbox/message/messageContent/messagePart/parentPart/@ref (minOccurs=0 maxOccurs=1) uuidType is used to specify a universally unique identifier (UUID).

The /myInbox/message/messageContent/messagePart/order (unsignedLong minOccurs=1 maxOccurs=1) element defines the order of this part relative to its siblings. The /myInbox/message/messageContent/messagePart/contentType (string minOccurs-1 maxOccurs=1) element defines the contentType of the part, (for example, message/rfc or text/plain.a).

The /myInbox/message/messageContent/messagePart/size (unsignedLong minOccurs=1 maxOccurs=1) field contains the size in bytes of the message part (including mime headers). The /myInbox/message/messageContent/messagePart/contentDisposition (string minOccurs=0 maxOccurs=1) element defines the content-disposition of the part, e.g., attachment; filename=“txt1.txt”.

The /myInbox/message/messageContent/messagePart/contentId (string minOccurs=0 maxOccurs=1) element defines the content-id of the part.

The /myInbox/message/messageContent/messagePart/contentLocation (string minOccurs=0 maxOccurs=1) element defines the content-location of the part.

The /myInbox/message/messageContent/messagePart/contentTransferEncoding (string minOccurs=0 maxOccurs=1) element defines the content-transfer-encoding of this part.

The /myInbox/message/messageContent/messagePart/partContent (base64Binary minOccurs=0 maxOccurs=1) elements contains the content of this message part and is only returned by including the ‘includePartContent’ element in the query options.

The /myInbox/message/messageContent/preview (string minOccurs=0 maxOccurs=1) field contains the first 256 characters of the message body. This element is only returned if the query option ‘includePreview’ is specified, to allow clients to selectively implement a preview-like message function or not, e.g., thin clients may not want to download an entire message just for a quick view. The /myInbox/message/messageContent/preview/@xml:lang (minOccurs=1 maxOccurs=1) required attribute is used to specify an ISO 639 language code or an ISO 3166 country code as described in RFC 1766. The value of this attribute indicates the language type of the content within this element. The /myInbox/message/messageContent/preview/®dir (string minOccurs=0 maxOccurs=1) optional attribute specifies the default layout direction for the localized string. Valid values are rtl (right to left) and ltr (left to right).

At times it may be desirable to a client to only obtain metadata about a message rather than downloading the message. The /myInbox/message/messageContent/single2822Header (string minOccurs=0 maxOccurs=unbounded) field contains the rfc2822 headers not included in the base schema (e.g., x-apparently-to). This element is returned by passing the ‘includeSingle2822Headers’ element in query options. The /myInbox/message/messageContent/raw2822Content (base64Binary minOccurs=0 maxOccurs=1) field contains the raw 2822 message (including headers and body) This element is returned by passing the includeRaw2822Contentelement in query options. The /myInbox/message/messageContent/raw2822Headers (base64Binary minOccurs=0 maxOccurs=1) field contains the raw rfc2822 headers not included in the base schema (e.g., x-apparently-to). This element is returned by passing the ‘includeRaw2822Headers’ element in query options.

The /myInbox/message/messageContent/{any} (minOccurs=0 maxOccurs=unbounded) field allows for extensibility.

A draft is a message that has not been sent. A draft node is defined that is similar in many ways to that of a regular message node. However, certain things about a draft message are different from received or sent messages, such as that they may be edited, do not have a date sent or date received time. The shape of a draft message is different, as well, and draft messages are likely to change, and thus the draft schema includes many red nodes.

In traditional email applications a draft message is stored in a Drafts folder and later sent. .NET Inbox allows for a draft to be stored in any folder. To this end, the /myInbox/draft (minOccurs=0 maxOccurs=unbounded) element defines a single draft in myInbox in the base schema. A draft represents an unsent email and is divided into two sub-groups ‘messageStatus’ and ‘messageContent’. The /myInbox/draft/@changeNumber (minOccurs=1 maxOccurs=1) changeNumber attribute is designed to facilitate caching of the element and its descendants. This attribute is assigned to this element by the .NET My Services system. The attribute is read only to applications. Attempts to write this attribute are silently ignored.

The /myInbox/draft/@id (minOccurs=1 maxOccurs=1) attribute is a globally unique ID assigned to this element by .NET My Services. Normally, .NET My Services generates and assigns this ID during an insertRequest operation or possibly during a replaceRequest. Application software can override this ID generation by specifying the useClientIds attribute in the request message. After an ID has been assigned, the attribute is read only and attempts to write it are silently ignored.

The /myInbox/draft/@creator (minOccurs=1 maxOccurs=1) attribute identifies the creator in terms of userId, appId, and platformId of the node.

The /myInbox/draft/draftStatus (minOccurs=1 maxOccurs=1) field contains the contents of this element represent the status metadata of the draft.

The /myInbox/draft/draftStatus/@changeNumber (minOccurs=1 maxOccurs=1) changeNumber attribute is designed to facilitate caching of the element and its descendants. This attribute is assigned to this element by the .NET My Services system. The attribute is read only to applications. Attempts to write this attribute are silently ignored.

The /myInbox/draft/draftStatus/isRead (boolean minOccurs=1 maxOccurs=1) element defines the read/unread state of the message and can be modified.

The /myInbox/draft/draftStatus/folder (minOccurs=1 maxOccurs=1) element defines the single folder that this message logically belongs to. For drafts this may point to the drafts folder, but also may point to another folder, enabling drafts to be stored in another folder.

The /myInbox/draft/draftStatus/folder/@ref (minOccurs=0 maxOccurs=1) uuidType is used to specify a universally unique identifier (UUID).

The /myInbox/draft/draftStatus/flag (minOccurs=0 maxOccurs=1) optional element defines the flag state of the message. It includes an {any} element that can be used for extensible flags.

The /myInbox/draft/draftStatus/flag/state (string minOccurs=1 maxOccurs=1) field contains the state of a message flag.

The /myInbox/draft/draftStatus/flag/title (string minOccurs=1 maxOccurs=1) field contains the client defined text of the flag. The /myInbox/draft/draftStatus/flag/title/@xml:lang (minOccurs=1 maxOccurs=1) required attribute is used to specify an ISO 639 language code or an ISO 3166 country code as described in RFC 1766. The value of this attribute indicates the language type of the content within this element. The /myInbox/draft/draftStatus/flag/title/@dir (string minOccurs=0 maxOccurs=1) optional attribute specifies the default layout direction for the localized string. Valid values are rtl (right to left) and ltr (left to right).

The /myInbox/draft/draftStatus/flag/reminderDate (dateTime minOccurs=0 maxOccurs=1) field contains the client defined reminder date of the flag. The /myInbox/draft/draftStatus/flag/{any} (minOccurs=0 maxOccurs=unbounded) field allows for extensibility. The /myInbox/draft/draftStatus/state (string minOccurs=1 maxOccurs=1) is an element, the value of which is ‘draft’. It is provided for compatibility with messages. The /myInbox/draft/draftStatus/{any} (minOccurs=0 maxOccurs=unbounded) field allows for extensibility.

The /myInbox/draft/draftContent (minOccurs=1 maxOccurs=1) element includes the contents that represent the content of the draft. The /myInbox/draft/draftContent/@changeNumber (minOccurs=1 maxOccurs=1) changeNumber attribute is designed to facilitate caching of the element and its descendants. This attribute is assigned to this element by the .NET My Services system. The attribute is read only to applications. Attempts to write this attribute are silently ignored.

The /myInbox/draft/draftContent/cat (minOccurs=0 maxOccurs=unbounded) element is used to categorize the element that contains it by referencing either a global category definition (in either the .NET Categories service system document or an external resource containing category definitions), or by referencing an identity-centered category definition in the content document of the .NET Categories service for a particular PUID.

The /myInbox/draft/draftContent/cat/@ref (anyURI minOccurs=1 maxOccurs=1) attribute references a category definition (catDef) element using the rules outlined in the .NET Categories section. (myCategories) described above.

The /myInbox/draft/draftContent/account (minOccurs=1 maxOccurs=1) element contains a reference to the /myInbox/account element ref from which this message should be sent.

The /myInbox/draft/draftContent/account/@ref (minOccurs=0 maxOccurs=1) uuidType is used to specify a universally unique identifier (UUID).

The /myInbox/draft/draftContent/draftType (minOccurs=1 maxOccurs=1) element includes subelements that describe the contents of the message. The /myInbox/draft/draftContent/draftType/type (string minOccurs=1 maxOccurs=1) element contains a value that provides the client with enough information to render an ‘Inbox’ view of the messages. Valid values are ‘voice’, ‘subscription’, ‘fax’, ‘dsn’, ‘readReceipt’, ‘meetingResponse’, ‘meetingRequest’, ‘email’ or ‘liveEmail’. The /myInbox/draft/draftContent/draftType/contentType (string minOccurs=0 maxOccurs=1) field contains the contentType of the message (in accordance with RFC 2045). Examples of this are: ‘text/plain’ and ‘multipart/mime’.

The /myInbox/draft/draftContent/draftType/l any) (minOccurs=0 maxOccurs=unbounded) field allows for extensibility.

The /myInbox/draft/draftContent/size (unsignedLong minOccurs=1 maxOccurs=1) read only element contains the size, in bytes, of the entire RFC2822 message in the store.

The /myInbox/draft/draftContent/importance (string minOccurs=1 maxOccurs=1) element indicates the importance of this message. Valid values include ‘low’, ‘normal’, or ‘high’. The default is ‘normal’.

The /myInbox/draft/draftContent/sensitivity (string minOccurs=1 maxOccurs=1) element indicates the sensitivity of the message. Valid values include ‘normal’, ‘personal’, ‘private’, or ‘confidential’.

The /myInbox/draft/draftContent/hasAttachments (boolean minOccurs=1 maxOccurs=1) read only element indicates whether a message has one or more attachments. The value will either be 0 (to indicate that the message has no attachments) or 1 (to indicate that the message has one or more attachments).

The /myInbox/draft/draftContent/conversationId (string minOccurs=0 maxOccurs=1) optional element identifies the ‘conversation,’ or e-mail thread of which this message is a part.

The /myInbox/draft/draftContent/conversationIndex (string minOccurs=0 maxOccurs=1) optional element identifies the ‘conversation,’ or e-mail thread of which this message is a part.

The /myInbox/draft/draftContent/subject (minOccurs=1 maxOccurs=1) field contains the subject of the message. This element contains both a prefix and text sub-elements to allow clients to sort on the non-prefix part of the subject (so RE: RE: doesn't get sorted). The /myInbox/draft/draftContent/subject/@xml:lang (minOccurs=1 maxOccurs=1) required attribute is used to specify an ISO 639 language code or an ISO 3166 country code as described in RFC 1766. The value of this attribute indicates the language type of the content within this element. The /myInbox/draft/draftContent/subject/@dir (string minOccurs=0 maxOccurs=1) optional attribute specifies the default layout direction for the localized string. Valid values are rtl (right to left), and ltr (left to right).

The /myInbox/draft/draftContent/subject/prefix (string minOccurs=1 maxOccurs=1) field contains the prefix of a message subject (e.g., ‘FW:’).

The /myInbox/draft/draftContent/subject/text (string minOccurs=1 maxOccurs=1) field contains the subject of a message minus the prefix (e.g., ‘hello there’).

The /myInbox/draft/draftContent/from (minOccurs=1 max0ccurs=1) read-only element describes who this message is from. To set this value, set the account element.

The /myInbox/draft/draftContent/from/name (string minOccurs=1 maxOccurs=1) field contains the display name of an e-mail address. The /myInbox/draft/draftContent/from/name/@xml:lang (minOccurs=1 maxOccurs=1) required attribute is used to specify an ISO 639 language code or an ISO 3166 country code as described in RFC 1766. The value of this attribute indicates the language type of the content within this element. The /myInbox/draft/draftContent/from/name/@dir (string minOccurs=0 maxOccurs=1) optional attribute specifies the default layout direction for the localized string. Valid values are rtl (right to left) and ltr (left to right).

The /myInbox/draft/draftContent/from/email (string minOccurs=1 max0ccurs=1) field contains an e-mail address (for example, someone@microsoft.com).

The /myInbox/draft/draftContent/recipient (minOccurs=0 maxOccurs=unbounded) field specifies the recipient of this message and where they appear.

The /myInbox/draft/draftContent/recipient/@type (string minOccurs=1 maxOccurs=1) field specifies whether the recipient is in the ‘to’, ‘cc’ or ‘bcc’ list.

The /myInbox/draft/draftContent/recipient/name (string minOccurs=1 maxOccurs=1) field contains the display name of an e-mail address. The /myInbox/draft/draftContent/recipient/name/@xml: lang (minOccurs=1 maxOccurs=1) required attribute is used to specify an ISO 639 language code or an ISO 3166 country code as described in RFC 1766. The value of this attribute indicates the language type of the content within this element. The /myInbox/draft/draftContent/recipient/name/@dir (string minOccurs=0 maxOccurs=1) optional attribute specifies the default layout direction for the localized string. Valid values are rtl (right to left) and ltr (left to right).

The /myInbox/draft/draftContent/recipient/email (string minOccurs=1 maxOccurs=1) field contains an e-mail address (for example, someone(microsoft.com).

The /myInbox/draft/draftContent/plainBody (string minOccurs=0 maxOccurs=1) field contains the plain body representation of the draft. The /myInbox/draft/draftContent/htmlBody (minOccurs=0 maxOccurs=1) field contains the html body representation of the draft. This element can optionally contain inline attachments. The /myInbox/draft/draftContent/htmlBody/body (string minOccurs=1 maxOccurs=1) field contains the contents of the body. The /myInbox/draft/draftContent/htmlBody/inlineAttachment (minOccurs=0 maxOccurs=unbounded) element represents an inline attachment.

The /myInbox/draft/draftContent/htmlBody/inlineAttachment/uri (string minOccurs=1 maxOccurs=1) field contains the client-defined unique identifier for the inline attachment. This element is used to identify this attachment location within the html body of a message.

The /myInbox/draft/draftContent/htmlBody/inlineAttachment/contentType (string minOccurs=1 maxOccurs=1) field contains the Content-Type of the attachment. The /myInbox/draft/draftContent/htmlBody/inlineAttachment/content (base64Binary minOccurs=1 maxOccurs=1) field contains the base64 encoded attachment content. The /myInbox/draft/draftContent/attachment (minOccurs=0 maxOccurs=unbounded) element represents a mail attachment.

The /myInbox/draft/draftContent/attachment/name (string minOccurs=1 maxOccurs=1) field contains the client defined name of the attachment. The /myInbox/draft/draftContent/attachment/ord (unsignedLong minOccurs=1 maxOccurs-1) specifies the unique order that this attachment should appear relative to all other attachments. The /myInbox/draft/draftContent/attachment/contentType (string minOccurs=1 maxOccurs=1) provides he Content-Type of the attachment.

The /myInbox/draft/draftContent/attachment/content (base64Binary minOccurs=1 maxOccurs=1) comprises the base64 encoded attachment content. The /myInbox/draft/draftContent/draftPart (minOccurs=1 maxOccurs=unbounded) element and its children define the message structure (including the mime body).

The /myInbox/draft/draftContent/draftPart/@changeNumber (minOccurs=1 maxOccurs=1) changeNumber attribute is designed to facilitate caching of the element and its descendants. This attribute is assigned to this element by the .NET My Services system. The attribute is read only to applications. Attempts to write this attribute are silently ignored.

The /myInbox/draft/draftContent/draftPart/parentPart (minOccurs=1 maxOccurs=1) element points to the parent part of this part. The /myInbox/draft/draftContent/draftPart/parentPart/@ref (minOccurs=0 maxOccurs=1) uuidType is used to specify a universally unique identifier (UUID).

The /myInbox/draft/draftContent/draftPart/order (unsignedLong minOccurs=1 maxOccurs=1) element defines the order of this part relative to its siblings. The /myInbox/draft/draftContent/draftPart/contentType (string minOccurs=1 maxOccurs=1) element defines the contentType of the part, (e.g., message/rfc or text/plain.a).

The /myInbox/draft/draftContent/draftPart/size (unsignedLong minOccurs=1 maxOccurs=1) field contains the size in bytes of the message part (including mime headers). The /myInbox/draft/draftContent/draftPart/contentDisposition (string minOccurs=0 maxOccurs=1) field contains the element defines the content-disposition of the part ex: attachment; filename=“txt1.txt”. The /myInbox/draft/draftContent/draftPart/contentId (string minOccurs=0 maxOccurs=1) element defines the content-id of the part. The /myInbox/draft/draftContent/draftPart/contentLocation (string minOccurs=0 maxOccurs=1) element defines the content-location of the part.

The /myInbox/draft/draftContent/draftPart/contentTransferEncoding (string minOccurs=0 maxOccurs=1) element defines the content-transfer-encoding of this part. The /myInbox/draft/draftContent/draftPart/partContent (base64Binary minOccurs=1 maxOccurs=1) elements contain the content of this message part. The /myInbox/draft/draftContent/draftPart/{any} (minOccurs=0 maxOccurs=unbounded) field allows for extensibility.

The /myInbox/draft/draftContent/preview (string minOccurs=0 maxOccurs=1) field contains the first 256 characters of the message body. This element is only returned if the query option ‘includepreview’ is specified. The /myInbox/draft/draftContent/preview/@xml:lang (minOccurs=1 maxOccurs=1) required attribute is used to specify an ISO 639 language code or an ISO 3166 country code as described in RFC 1766. The value of this attribute indicates the language type of the content within this element. The /myInbox/draft/draftContent/preview/@dir (string minOccurs=0 max0ccurs=1) optional attribute specifies the default layout direction for the localized string. Valid values are rtl (right to left) and ltr (left to right).

The /myInbox/draft/draftContent/single2822Header (string minOccurs=0 max0ccurs=unbounded) field contains the rfc2822 headers not included in the base schema (e.g., x-apparently-to). This element is returned by passing the ‘includeSingle2822Headers’ element in query options.

The /myInbox/draft/draftContent/raw2822Content (base64Binary minOccurs=0 maxOccurs=1) field contains the raw 2822 message (including headers and body) This element is returned by passing the includeRaw2822Contentelement in query options. The /myInbox/draft/draftContent/raw2822Headers (base64Binary minOccurs=0 maxOccurs=1) field contains the raw rfc2822 headers not included in the base schema (e.g., x-apparently-to). This element is returned by passing the ‘includeRaw2822Headers’ element in query options. The /myInbox/draft/draftContent/{any} (minOccurs=0 maxOccurs=unbounded) and the /myInbox/draft/{any} (minOccurs=0 maxOccurs=unbounded) fields allow for extensibility.

The /myInbox/rule (minOccurs=0 maxOccurs=unbounded) field contains rules that specify actions that should be performed on the active message during sending or delivery. For example, certain messages may be moved to a particular folder via a rule, while out-of-office is also implemented via rule. The /myInbox/rule/@sequence (unsignedLong minOccurs=1 maxOccurs=1) required attribute specifies the order in which this action should be performed, relative to other actions for this rule.

Most email applications allow for rules, however rules expressed by one email application normally cannot be consumed by another application, forcing each client to invent a new storage mechanism. In .NET Inbox there is a single schema for how a rule is stored. For example, the sample schema table below would move new messages with the importance set to high to the Important mail folder:

<myInbox>

<folder id=“123>

<name xml:lang=“en”>Important</name>

</folder>
<rule>

<name xml:lang=“en”>Move high priority email to
Important folder</name>
<enabled>True</enabled>
<runat>server</runat>
<condition

select=“./importance = ‘high’”>

</condition>
<action>

<moveMessage>

<targetFolder ref=“123”/>

</moveMessage>

</action>

</rule>

</myInbox>

Expressing this rule structure in XML allows all clients to know what the rules are and which are run by the server and which by the client.

The /myInbox/rule/@changeNumber (minOccurs=1 maxOccurs=1) changeNumber attribute is designed to facilitate caching of the element and its descendants. This attribute is assigned to this element by the .NET My Services system. The attribute is read only to applications. Attempts to write this attribute are silently ignored.

The /myInbox/rule/@id (minOccurs=1 maxOccurs=1) attribute is a globally unique ID assigned to this element by .NET My Services. Normally, .NET My Services generates and assigns this ID during an insertRequest operation or possibly during a replaceRequest. Application software can override this ID generation by specifying the useClientIds attribute in the request message. After an ID has been assigned, the attribute is read only and attempts to write it are silently ignored.

The /myInbox/rule/@creator (minOccurs=1 maxOccurs=1) attribute identifies the creator in terms of userId, appId, and platformId of the node. The /myInbox/rule/name (string minOccurs=1 maxOccurs=1) field contains the application-defined, human readable identifier of the rule. The /myInbox/rule/name/@xml:lang (minOccurs=1 maxOccurs=1) required attribute is used to specify an ISO 639 language code or an ISO 3166 country code as described in RFC 1766. The value of this attribute indicates the language type of the content within this element. The /myInbox/rule/name/@dir (string minOccurs=0 maxOccurs=1) optional attribute specifies the default layout direction for the localized string. Valid values are rtl (right to left) and ltr (left to right).

The /myInbox/rule/state (string minOccurs=1 maxOccurs=1) field indicates whether the rule represented by this node is currently enabled. The /myInbox/rule/runat (string minOccurs=1 maxOccurs=1) required attribute specifies where the rule must run. For example, rules may be run at a server, wherein the value is ‘server’, or may be run at a client.

The /myInbox/rule/runwhen (string minOccurs=1 maxOccurs=1) required attribute specifies when the rule must run. Allowable values include ‘sending’ and ‘receiving’.

The /myInbox/rule/type (string minOccurs=1 maxOccurs=1) field specifies if this is of type ‘oof’ or ‘normal’.

The /myInbox/rule/provider (string minOccurs=1 maxOccurs=1) field contains the application-defined provider of the rule. This is provided so that multiple applications can (if they so desire) only alter their own rules. The /myInbox/rule/provider/@xml:lang (minOccurs=1 maxOccurs=1) required attribute is used to specify an ISO 639 language code or an ISO 3166 country code as described in RFC 1766. The value of this attribute indicates the language type of the content within this element. The /myInbox/rule/provider/@dir (string minOccurs=0 maxOccurs=1) optional attribute specifies the default layout direction for the localized string. Valid values are rtl (right to left) and ltr (left to right).

The /myInbox/rule/condition (minOccurs=1 maxOccurs=1) element's select attribute specifies the xpath expression used to evaluate if this rule applies to the active message. The /myInbox/rule/condition/@select (string minOccurs=1 maxOccurs=1) attribute specifies an xpath expression used to determine if this rule applies to the active message. Because rules only apply to messages, this statement must be scoped to the message element. Valid examples include “/importance =‘high’”;“/from/email=‘someone(microsoft.com’ and contains (./subject/full, ‘hello’)”. Examples of invalid statements include “/myInbox/message[./importance =‘high’]”; “/myInbox/folder”; “/myInbox/rule”.

The /myInbox/rule/action (minOccurs=1 maxOccurs=unbounded) field specifies an individual action to perform if the select element matches minOccurs-maxOccurs messages. The /myInbox/rule/action/@sequence (unsignedLong minOccurs=1 maxOccurs=1) required attribute specifies the order that this action should be performed in relative to all other actions for this rule. The /myInbox/rule/action/copyMessage (minOccurs=0 maxOccurs=1) action is used to copy the active message in rules processing to another folder specified by the ‘targetFolder’ element.

The /myInbox/rule/action/copyMessage/targetFolder (minOccurs=1 maxOccurs=1) element specifies the folder to save the message to. If omitted, the message is saved in the drafts folder. The /myInbox/rule/action/copyMessage/targetFolder/@select (string minOccurs=1 maxOccurs=1) field contains the location of the folder to which save the message. For example, The /myInbox/folder[@id=“”].

The /myInbox/rule/action/moveMessage (minOccurs=0 maxOccurs=1) field is used in rule actions to indicate that the active message should be moved to the targetFolder. The /myInbox/rule/action/moveMessage/targetFolder (minOccurs=1 maxOccurs=1) element specifies the folder to save the message to. If omitted, the message is saved in the drafts folder.

The /myInbox/rule/action/moveMessage/targetFolder/@select (string minOccurs=1 maxOccurs=1) field contains the location of the folder to which save the message. For example, The /myInbox/folder[@id=“”].

The /myInbox/rule/action/deleteMessage (minOccurs=0 maxOccurs=1) field is used in rule actions to indicate that the active message should be deleted. The /myInbox/rule/action/assignCategory (minOccurs=0 maxOccurs=1) field is used in rule actions to indicate that the active message should have the included cat element added to it.

The /myInbox/rule/action/assignCategory/cat (minOccurs=0 maxOccurs=unbounded) element is used to categorize the element that contains it by referencing either a global category definition (in either the .NET Categories service system document or an external resource containing category definitions), or by referencing an identity-centered category definition in the content document of the .NET Categories service for a particular PUID.

The /myInbox/rule/action/assignCategory/cat/@ref (anyURI minOccurs=1 maxOccurs=1) attribute references a category definition (catDef) element using the rules outlined in the .NET Categories section (myCategories) described above.

The /myInbox/rule/action/forwardMessage (minOccurs=0 maxOccurs=1) field is used in rule actions to indicate that the active message should be forwarded to the included recipients. The /myInbox/rule/action/forwardMessage/recipient (minOccurs=0 maxOccurs=unbounded) field specifies an e-mail address and display name, or the PUID that represents them.

The /myInbox/rule/action/forwardMessage/recipient/@type (string minOccurs=1 maxOccurs=1) field specifies whether the recipient is in the ‘to’, ‘cc’ or ‘bcc’ list.

The /myInbox/rule/action/forwardMessage/recipient/name (string minOccurs=1 maxOccurs=1) field contains the display name of an e-mail address. The /myInbox/rule/action/forwardMessage/recipient/name/@xml:lang (minOccurs=1 maxOccurs=1) required attribute is used to specify an ISO 639 language code or an ISO 3166 country code as described in RFC 1766. The value of this attribute indicates the language type of the content within this element. The /myInbox/rule/action/forwardMessage/recipient/name/@dir (string minOccurs=0 maxOccurs=1) optional attribute specifies the default layout direction for the localized string. Valid values are rtl (right to left) and ltr (left to right). The /myInbox/rule/action/forwardMessage/recipient/email (string minOccurs=1 maxOccurs=1) field contains an e-mail address (for example, someone@microsoft.com).

The /myInbox/rule/action/forwardAsAttachment (minOccurs=0 maxOccurs=1) field is used in rule actions to indicate that the active message should be forwarded to the included recipients as an attachment. The /myInbox/rule/action/forwardAsAttachment/recipient (minOccurs=0 maxOccurs=unbounded) field specifies an e-mail address and display name, or the PUID that represents them. The /myInbox/rule/action/forwardAsAttachment/recipient/@type (string minOccurs=1 maxOccurs=1) field specifies whether the recipient is in the ‘to’, ‘cc’ or ‘bcc’ list.

The /myInbox/rule/action/forwardAsAttachment/recipient/name (string minOccurs=1 maxOccurs=1) field contains the display name of an e-mail address. The /myInbox/rule/action/forwardAsAttachment/recipient/name/@xml:lang (minOccurs=1 maxOccurs=1) required attribute is used to specify an ISO 639 language code or an ISO 3166 country code as described in RFC 1766. The value of this attribute indicates the language type of the content within this element. The /myInbox/rule/action/forwardAsAttachment/recipient/name/@dir (string minOccurs=0 maxOccurs=1) optional attribute specifies the default layout direction for the localized string. Valid values are rtl (right to left) and ltr (left to right).

The /myInbox/rule/action/forwardAsAttachment/recipient/email (string minOccurs=1 maxOccurs=1) field contains an e-mail address (for example, someone@microsoft.com).

The /myInbox/rule/action/serverReply (minOccurs=0 maxOccurs=1) field, if present, includes the /myInbox/rule/action/serverReply/subject (minOccurs=1 maxOccurs=1) field which contains the subject of the message from the server. The /myInbox/rule/action/serverReply/subject/@xml: lang (minOccurs=1 maxOccurs=1) required attribute is used to specify an ISO 639 language code or an ISO 3166 country code as described in RFC 1766. The value of this attribute indicates the language type of the content within this element. The /myInbox/rule/action/serverReply/subject/@dir (string minOccurs=0 maxOccurs=1) optional attribute specifies the default layout direction for the localized string. Valid values are rtl (right to left), and ltr (left to right).

The /myInbox/rule/action/serverReply/subject/prefix (string minOccurs=1 maxOccurs=1) field contains the prefix of a message subject (e.g., ‘FW:’). The /myInbox/rule/action/serverReply/subject/text (string minOccurs=1 maxOccurs=1) field contains the subject of a message, minus the prefix (e.g., ‘hello there’).

The /myInbox/rule/action/serverReply/simpleBody (string minOccurs=1 maxOccurs 1) field contains a plain text simple body that should be sent from the server. The /myInbox/rule/action/serverReply/simpleBody/@xml: lang (minOccurs=1 maxOccurs=1) required attribute is used to specify an ISO 639 language code or an ISO 3166 country code as described in RFC 1766. The value of this attribute indicates the language type of the content within this element. The /myInbox/rule/action/serverReply/simpleBody/@dir (string minOccurs=0 maxOccurs=1) optional attribute specifies the default layout direction for the localized string. Valid values are rtl (right to left) and ltr (left to right).

The /myInbox/rule/action/redirectMessage (minOccurs=0 maxOccurs=1) field is used in rule actions to indicate that the active message should be redirected to the included recipient. The /myInbox/rule/action/redirectMessage/recipient (minOccurs=0 maxOccurs=unbounded) field specifies an e-mail address and display name, or the PUID that represents them. The /myInbox/rule/action/redirectMessage/recipient/@type (string minOccurs=1 maxOccurs=1) specifies whether the recipient is in the ‘to’, ‘cc’ or ‘bcc’ list.

The /myInbox/rule/action/redirectMessage/recipient/name (string minOccurs=1 maxOccurs=1) field contains the display name of an e-mail address. The /myInbox/rule/action/redirectMessage/recipient/name/@xml:lang (minOccurs=1 maxOccurs=1) required attribute is used to specify an ISO 639 language code or an ISO 3166 country code as described in RFC 1766. The value of this attribute indicates the language type of the content within this element. The /myInbox/rule/action/redirectMessage/recipient/name/@dir (string minOccurs=0 maxOccurs=1) optional attribute specifies the default layout direction for the localized string. Valid values are rtl (right to left) and ltr (left to right).

The /myInbox/rule/action/redirectMessage/recipient/email (string minOccurs=1 maxOccurs=1) field contains an e-mail address (for example, someone@microsoft.com).

The /myInbox/rule/action/flagMessage (minOccurs=0 maxOccurs=1) field is used in rule actions to indicate that the active message should have the included flag added to it. The /myInbox/rule/action/flagMessage/flag (minOccurs=1 maxOccurs=1) optional element defines the flag state of the message. It includes an {any} element that can be used for extensible flags.

The /myInbox/rule/action/flagMessage/flag/state (string minOccurs=1 maxOccurs=1) field contains the state of a message flag. The /myInbox/rule/action/flagMessage/flag/title (string minOccurs=1 maxOccurs=1) field contains the client-defined text of the flag. The myInbox/rule/action/flagMessage/flag/title/@xml:lang (minOccurs=1 maxOccurs=1) required attribute is used to specify an ISO 639 language code or an ISO 3166 country code as described in RFC 1766. The value of this attribute indicates the language type of the content within this element. The /myInbox/rule/action/flagMessage/flag/title/@dir (string minOccurs=0 maxOccurs=1) optional attribute specifies the default layout direction for the localized string. Valid values are rtl (right to left) and ltr (left to right).

The /myInbox/rule/action/flagMessage/flag/reminderDate (dateTime minOccurs=0 maxOccurs=1) field contains the client-defined reminder date of the flag. The /myInbox/rule/action/flagMessage/flag/{any} (minOccurs=0 maxOccurs=unbounded) field allows for extensibility.

The /myInbox/rule/action/markAsRead (minOccurs=0 maxOccurs=1) field is used in rule actions to indicate that the active message should be marked as read. The /myInbox/rule/action/stopProcessingRulesOfThisType (minOccurs=0 maxOccurs=1) is directed to stopping certain rules from processing, e.g., if a rule has already handled a received message, certain other rules should not process it.

The /myInbox/rule/{any} (minOccurs=0 maxOccurs=unbounded) field allows for extensibility.

The myInbox content document include a subscription node that essentially takes action when items change, such as to propagate information about the change to other services.

The /myInbox/subscription (minOccurs=0 maxOccurs=unbounded) element defines a subscription node that is designed to be an xdb:blue node which when placed in a content document causes a subscription to be registered, (wherein as used herein, the string “myInbox” referred to in this section can be replaced by an appropriate service name, e.g., “myApplicationSettings” or “myInbox” or “myWallet” and so forth). A subscription contains a trigger element which selects a scope of coverage. When items that are under this scope of coverage change, a subscriptionResponse message is generated and sent to the specified destination address.

The /myInbox/subscription/@changeNumber (minOccurs=0 maxOccurs=1) changeNumber attribute is designed to facilitate caching of the element and its descendants. This attribute is assigned to this element by the .NET My Services system, and the attribute is read-only to applications; attempts to write this attribute are silently ignored. The /myInbox/subscription/@id (minOccurs=0 maxOccurs=1) attribute is a globally unique ID assigned to this element by .NET My Services. Normally, .NET My Services will generate and assign this ID during an insertRequest operation, or possibly during a replaceRequest. Application software can override this ID generation by specifying the useClientIds attribute in the request message. Once an ID is assigned, the attribute is read-only and attempts to write it are silently ignored.

The /myInbox/subscription/@creator (string minOccurs=0 maxOccurs=1) attribute identifies the creator in terms of userId, appId, and platformId of the node. The /myInbox/subscription/trigger (minOccurs=1 maxOccurs=1) includes the /myInbox/subscription/trigger/@select (string minOccurs=0 maxOccurs=1) item, which specifies an XPATH expression that specifies the nodes that are to be selected and watched for changes. The selection may only select xdb:blue nodes, as described above. A s changes in this node set occur, they trigger the generation of a subscription message. These messages are then sent to the SOAP receiver listed in the “to” element.

The /myInbox/subscription/trigger/@mode (string minOccurs=0 maxOccurs=1) attribute specifies whether or not the content of the changes that triggered the subscription are delivered in the subscription message, or if the message simply indicates that something changed under the trigger. The attribute may comprise includeData, namely that the data that changed and caused the subscription to trigger is included in the subscription message. Note that deleted nodes are specified by their id, not by value. Alternatively the attribute may comprise excludeData, whereby the data that changed, causing the subscription to trigger, is not included in the subscription message.

The /myInbox/subscription/trigger/@baseChangeNumber (minOccurs=0 maxOccurs=1) attribute specifies the changeNumber value that the trigger is relative to. All changes between the specified change number, and the current state of the document relative to the selection are transmitted as subscription messages. This allows a client application to establish a subscription relative to some baseline. As in changeQuery, if the baseChangeNumber is way out of date relative to the current state of the document, and the service can not supply the changes in the subscription message, the subscription insert is rejected. A value of zero (0) means that the current values of the selected nodes are transmitted in the subscription message.

The /myInbox/subscription/expiresAt (dateTime minOccurs=0 maxOccurs=1) optional element specifies an absolute time after which the subscription is no longer active. The subscription node is automatically removed when the subscription expires. If this element is missing, the subscription does not expire. The /myInbox/subscription/context (minOccurs=1 maxOccurs=1) element returns the context element from the original subscription. Applications should use this element to correlate the subscription response with one of their subscriptions.

The /myInbox/subscription/context/@uri (anyURI minOccurs=0 maxOccurs=1) attribute specifies the URI value chosen by the subscriber that is associated with this subscription. The /myInbox/subscription/context/{any} (minOccurs=0 maxOccurs=unbounded) including the /myInbox/subscription/to (anyURI minOccurs=1 maxOccurs=1) attribute specifies the location that is to receive the subscription message. The value of this element may be hs:myAlerts, whereby this URI indicates that generated subscription messages are to be delivered inside the body of a notification and delivered to the default .NET Alerts service of the creator. Alternatively, the value may be protocol://service, whereby this URI indicates that generated subscription messages are delivered to the specified service at the domain of the creator's platformId. For example, a platformId indicating microsoft.com, and a value in this element of http://subscriptionResponse would cause delivery of the subscription message to http://subscriptionResponse.microsoft.com. If this value is not specified, then the subscription message is delivered as a notification to the “creator's”.NET Alerts service. The /myInbox/{any} (minOccurs=0 maxOccurs=unbounded) field allows for extensibility.

MyInbox/System

The system document is a global document for each service, having content and meaning that is independent of the puid used to address the service. The document is read only to all users. Each system document contains a set of base items common to each of the NET My Services described herein, and is optionally extended by each service to include service-specific global information. The following schema outline illustrates the layout and meaning of the information found in the myInbox system document:

TABLE
/*actual service name*/ system

<sys:system changeNumber=“...” instanceId=“ ...”

xmlns:hs=“ http://schemas.microsoft.corn/hs/2001/10/core”
xmlns:sys=“ http://schemas.microsoft.com/hs/2001/10The/*actual
service name*/system”>_{1. 1}
<hs:systemVersion changeNumber=“ ...” id=“ ...” creator=“ ...”>_{1..1}

<hs:version majorVersion=“ ...” minorVersion=“ ...” buildNumber=“ ...” qfe=“ ...”>_{1 1}

<hs:productReleaseName>_{1. 1}</hs:productReleaseName>
<hs:productImplementationName>_{1 1}</hs:productImplementationName>

</hs:version>
<hs:buildDate>_{1.1}</hs:buildDate>
<hs:buildDetails machine=“ ...” branch=“ ...” type=“ ...” official=“ ...”>_{1. 1}</hs:buildDetails>

</hs:systemVersion>
<hs:roleMap changeNumber=“ ...” id=“ ...” creator=“ ...”>_{1 1}

<hs:scope id=“ ...”>_{0 unbounded}

<hs:name xml:lang=“ ...” dir=“ ...”>_{0 unbounded}</hs:name>
<hs:shape base=“ ...”>_{1 1}

<hs:include select=“ ...”>_{0..unbounded}</hs:include>
<hs:exclude select=“ ...”>_{0 unbounded}</hs:exclude>

</hs:shape>

</hs:scope>
<hs:roleTemplate name=“ ...” priority=“ ...”>_{0 unbounded}

<hs:fullDescription xml:lang=“ ...” dir=“ ...”>_{0.1}</hs:fullDescription>
<hs:method name=“ ...” scopeRef=“ ...”>_{0 unbounded}</hs:method>

</hs:roleTemplate>

</hs:roleMap>
<hs:methodMap changeNumber=“ ...” id=“ ...” creator=“ ...”>_{1 1}

<hs:method name=“ ...”>_{0 unbounded}{any}</hs:method>

</hs:methodMap>
<hs:schemaMap changeNumber=“ ...” id=“ ...” creator=“ ...”>_{1 1}

<hs:schema namespace=“ ...” schemaLocation=“ ...” alias=“ ...”>_{0 unbounded}{any}</hs:schema>

</hs:schemaMap>
<hs:wsdlMap changeNumber=“ ...” id=“ ...” creator=“ ...”>_{1 1}

<hs:wsdl wsdlLocation=“ ...”>_{0 unbounded}{any}</hs:wsdl>
<hs:disco discoLocation=“ ...”>_{0 unbounded}{any}</hs:disco>
<hs:wsil wsilLocation=“ ...”>_{0..unbounded}{any}</hs:wsil>

</hs:wsdlMap>

</any>
</sys:system>

The meaning of the attributes and elements shown in the preceding sample document outline follow, beginning with /system (minOccurs=1 maxOccurs=1), the element that encapsulates a system document common to the various services. Although each service has its own system document, the common system document attributes and elements are described once, for purposes of simplicity, with service-specific system document attributes and elements specified for each service, below. The /system/@changeNumber (minOccurs=0 maxOccurs=1) attribute is designed to facilitate caching of the element and its descendants. This attribute is assigned to this element by the .NET My Services system. The attribute is read-only to applications. Attempts to write this attribute are silently ignored.

The /system/@instanceId (string minOccurs=0 maxOccurs=1) attribute is a unique identifier typically assigned to the root element of a service. It is a read-only element and assigned by the .NET My Services system when a user is provisioned for a particular service.

The /system/systemVersion (minOccurs=1 maxOccurs=1) element defines version information describing this instance of the .NET MyServices service. The /systemVersion/@changeNumber (minOccurs=0 maxOccurs=1) changeNumber attribute is designed to facilitate caching of the element and its descendants. This attribute is assigned to this element by the .NET My Services system. The attribute is read-only to applications; attempts to write this attribute are silently ignored, (e.g., without generating an error).

The /system/systemVersion/@id (minOccurs=0 maxOccurs=1) attribute is a globally unique ID assigned to this element by .NET My Services. Normally, .NET My Services will generate and assign this ID during an insertRequest operation, or possibly during a replaceRequest. Application software can override this ID generation by specifying the useClientIds attribute in the request message. Once an ID is assigned, the attribute is read-only and attempts to write it are silently ignored.

The /system/systemVersion/@creator (string minOccurs=0 maxOccurs=1) attribute identifies the creator in terms of userId, appId, and platformId of the node. The /system/systemVersion/version (minOccurs=1 maxOccurs=1) element defines major, minor, and build number version information. The /system/systemVersion/version/@majorVersion (string minOccurs=0 maxOccurs=1) attribute specifies the major version number of the .NET MyServices service.

The /system/systemVersion/version/@minorVersion (string minOccurs=0 maxOccurs=1) attribute specifies the minor version number of the .NET MyServices service. The /system/systemVersion/version/@buildNumber (string minOccurs=0 maxOccurs=1) attribute specifies the buildNumber of the .NET MyServices service. The /system/systemVersion/version/@qfe (string minOccurs=0 maxOccurs=1) attribute specifies the qfe version number of the .NET MyServices service. The /system/systemVersion/version/productReleaseName (string minOccurs=1 maxOccurs=1) element defines the major product release string (as in .NET My Services Beta 1, and so on). The /system/systemVersion/version/productImplementationName (anyURI minOccurs=1 maxOccurs—1) element defines the class of the service to differentiate between different implementations.

The /system/systemVersion/buildDate (dateTime minOccurs=1 maxOccurs=1) element defines the date and time that the .NET My Services system was built. The time is in UTC (Z relative) form. The /systemVersion/buildDetails (minOccurs=1 maxOccurs=1) element defines details of the build including the machine that generated the build, the branch id of the software that contributed to the build, the type of build (chk/fre), and if the build was generated by an official build release process.

The /system/systemVersion/buildDetails/@machine (string minOccurs=0 maxOccurs=1) attribute specifies the machine that generated the build. The system/systemVersion/buildDetails/@branch (string minOccurs=0 maxOccurs=1) attribute specifies the software branch id for the source code that contributed to this build. The /system/systemVersion/buildDetails/@type (string minOccurs=0 maxOccurs=1) attribute specifies the type of build. A value of chk indicates that this is a checked or debug build. A value of fre indicates that this is a retail build. The /system/systemVersion/buildDetails/@official (string minOccurs=0 maxOccurs=1) attribute indicates that the build was produced by an official build process (value of yes), or an unofficial process (value of no).

The /system/roleMap (minOccurs=1 maxOccurs=1) element encapsulates all the elements that make up a roleMap, which include document class relative roleTemplate, priority, name, method, and per-method scope. An individual roleTemplate defines the maximum scope of information, and the allowable methods used to access that information for each request mapped into the template. The /system/roleMap/@changeNumber (minOccurs=0 maxOccurs=1) changeNumber attribute is designed to facilitate caching of the element and its descendants. This attribute is assigned to this element by the .NET My Services system. The attribute is read-only to applications. Attempts to write this attribute are silently ignored. The /system/roleMap/@id (minOccurs=0 maxOccurs=1) attribute is a globally unique ID assigned to this element by .NET My Services. Normally, .NET My Services will generate and assign this ID during an insertRequest operation, or possibly during a replaceRequest. Application software can override this ID generation by specifying the useClientIds attribute in the request message. Once an ID is assigned, the attribute is read-only and attempts to write it are silently ignored.

The /system/roleMap/@creator (string minOccurs=0 maxOccurs=1) attribute identifies the creator in terms of userId, appId, and platformId of the node. The /system/roleMap/scope (minOccurs=0 maxOccurs=unbounded) element defines a scope which may be referred to by roles within this roleMap to indicate what portions of the document are visible to this role for the specified method.

The /system/roleMap/scope/@id (minOccurs=0 maxOccurs=1) attribute is a globally unique ID assigned to this element by .NET My Services. Normally, .NET My Services will generate and assign this ID during an insertRequest operation, or possibly during a replaceRequest. Application software can override this ID generation by specifying the useClientIds attribute in the request message. Once an ID is assigned, the attribute is read-only and attempts to write it are silently ignored. The /system/roleMap/scope/name (string minOccurs=0 maxOccurs=unbounded) node includes the /system/roleMap/scope/name/@xml:lang (minOccurs=1 maxOccurs=1) required attribute, which is used to specify an ISO 639 language code or an ISO 3166 country code as described in RFC 1766. The value of this attribute indicates the language type of the content within this element. The /system/roleMap/scope/name/@dir (string minOccurs=0 maxOccurs=1) optional attribute specifies the default layout direction for the localized string. Valid values are rtl (right to left), and ltr (left to right).

The /system/roleMap/scope/shape (minOccurs=1 maxOccurs=1) comprises a shape that defines the node set that is visible through the document when operating through this shape element. The /system/roleMap/scope/shape/@base (string minOccurs=0 maxOccurs=1) attribute specifies the initial set of nodes visible through the shape. A value of t indicates that the shape is initialized to include all possible nodes relative to the shape that is currently in effect. For instance, each role defines a scope containing a shape. When defining a shape for a role, the value t indicates all possible nodes available in the specified document for this role. When defining a shape in an ACL entry, a value of t means all of the nodes visible in the shape for the computed role. When using a shape in a data language (e.g., query, insert, replace and so on) operation, a value of t indicates all of the possible nodes selected by the data language operation (relative to the ACL shape which itself is relative to the role's shape). The value nil indicates the opposite of t, which is the empty node set. Nodes from this set may then be included into the shape.

The /system/roleMap/scope/shape/include (minOccurs=0 maxOccurs=unbounded) element specifies the set of nodes that should be included into the shape relative to the possible set of nodes indicated by the base attribute. The /system/roleMap/scope/shape/include/@select (string minOccurs=0 maxOccurs=1) item specifies an XPATH expression that selects a set of nodes relative to the externally established context. The expression can never travel outside the node-set established by this externally established current context. The expression may match zero or more nodes, and the operation manipulates all selected nodes. The minOccurs and maxOccurs attributes are optional and place restrictions and limitations on the number of nodes selected.

The /system/roleMap/scope/shape/exclude (minOccurs=0 maxOccurs=unbounded) element specifies the set of nodes that should be excluded from the shape relative to the possible set of nodes indicated by the base attribute. The /system/roleMap/scope/shape/exclude/@select (string minOccurs=0 maxOccurs-1) item specifies an XPATH expression that selects a set of nodes relative to the externally established context. The expression can never travel outside the node-set established by this externally established current context. The expression may match zero (0) or more nodes, and the operation manipulates all selected nodes. The minOccurs and maxOccurs attributes are optional and place restrictions and limitations on the number of nodes selected. The /system/roleMap/roleTemplate (minOccurs=0 maxOccurs=unbounded) element encapsulates the definition of a role. The attribute set for this element includes the document class that this roleTemplate refers to, the name of the roleTemplate, and the priority of the roleTemplate.

The /system/roleMap/roleTemplate/@name (string minOccurs=0 maxOccurs=1) element specifies the name of the role. The /system/roleMap/roleTemplate/@priority (int minOccurs=0 maxOccurs=1) element specifies the priority of the roleTemplate which is used to select that actual roleTemplate when the role evaluation determines that the subject maps to multiple roleTemplates.

The /system/roleMap/roleTemplate/fullDescription (string minOccurs=0 maxOccurs=1) element contains a description of this role template which specifies the capabilities a caller will have when accessing information through this role. The /system/roleMap/roleTemplate/fullDescription/@xml:lang (minOccurs=1 maxOccurs=1) required attribute is used to specify an ISO 639 language code or an ISO 3166 country code as described in RPC 1766. The value of this attribute indicates the language type of the content within this element. The /system/roleMap/roleTemplate/fullDescription/@dir (string minOccurs=0 maxOccurs=1) optional attribute specifies the default layout direction for the localized string. Valid values are rtl (right to left), and ltr (left to right).

The /system/roleMap/roleTemplate/method (minOccurs=0 maxOccurs=unbounded) element specifies the methods available within this roleTemplate by name, and by scope. When a subject maps to a roleTemplate, the method in the request must match one of these elements for the message to continue to flow. If the method exists, the data available to the method is a function of the scope referenced by this method combined with an optional scope referenced by the role defined in the roleList.

The /system/roleMap/roleTemplate/method/@name (string minOccurs=0 maxOccurs=1) element specifies the name of the method. The /system/roleMap/roleTemplate/method/@scopeRef (string minOccurs=0 maxOccurs=1) attribute specifies the scope within this document that is in effect for this method. The /system/methodMap (minOccurs=1 maxOccurs=1) element defines the methodMap. While in most cases, the roleMap section contains a definitive list of methods, these methods are likely to be scattered about the roleMap in various templates. This section contains the definitive non-duplicated list of methods available within the service.

The /system/methodMap/@changeNumber (minOccurs=0 maxOccurs=1) changeNumber attribute is designed to facilitate caching of the element and its descendants. This attribute is assigned to this element by the .NET My Services system. The attribute is read-only to applications. Attempts to write this attribute are silently ignored.

The /system/methodMap/@id (minOccurs=0 maxOccurs=1) attribute is a globally unique ID assigned to this element by .NET My Services. Normally, .NET My Services will generate and assign this ID during an insertRequest operation, or possibly during a replaceRequest. Application software can override this ID generation by specifying the useClientIds attribute in the request message. Once an ID is assigned, the attribute is read-only and attempts to write it are silently ignored. The /system/methodMap/@creator (string minOccurs=0 maxOccurs=1) attribute identifies the creator in terms of userId, appId, and platformId of the node.

The /system/methodMap/method (minOccurs=0 maxOccurs=unbounded) element defines a method that is available within this service. The /system/methodMap/method/@name (string minOccurs=0 maxOccurs=1) attribute specifies the name of a method available within the service. The /system/methodMap/method/{any} (minOccurs=0 maxOccurs=unbounded) provides for extensibility. The /system/schemaMap (minOccurs=1 maxOccurs=1) element defines the various schema's that define the data structures and shape of information managed by this service. Each schema is defined by its namespace URI, its location, and a preferred namespace alias.

The /system/schemaMap/@changeNumber (minOccurs=0 maxOccurs=1) changeNumber attribute is designed to facilitate caching of the element and its descendants. This attribute is assigned to this element by the .NET My Services system. The attribute is read-only to applications. Attempts to write this attribute are silently ignored.

The /system/schemaMap/@id (minOccurs=0 maxOccurs=1) attribute is a globally unique ID assigned to this element by .NET My Services. Normally, .NET My Services will generate and assign this ID during an insertRequest operation, or possibly during a replaceRequest. Application software can override this ID generation by specifying the useClientIds attribute in the request message. Once an ID is assigned, the attribute is read-only and attempts to write it are silently ignored.

The /system/schemaMap/@creator (string minOccurs=0 maxOccurs=1) attribute identifies the creator in terms of userId, appId, and platformId of the node. The /system/schemaMap/schema (minOccurs=0 maxOccurs=unbounded) element defines a schema which defines data-structures and the shape of information managed by this service. Multiple schema elements exist for each service, once for each logical grouping of information exposed by the service. The /system/schemaMap/schema/@namespace (anyURI minOccurs=0 maxOccurs=1) attribute specifies the namespace URI of this schema. The /system/schemaMap/schema/@schemaLocation (anyURI minOccurs=0 maxOccurs=1) attribute specifies the location (in the form of a URI) of the resource containing schema. When a schema is reachable through a variety of URIs, one schema element will exist for each location.

The /system/schemaMap/schema/@alias (string minOccurs=0 maxOccurs=1) attribute specifies the preferred alias that should be used if possible when manipulating information covered by this schema in the context of this service. The /system/schemaMap/schema/{any} (minOccurs=0 maxOccurs=unbounded) provides for extensibility. The /system/wsdlMap (minOccurs=1 maxOccurs=1) element defines the wsdlMap for this service. This map includes the location of WSDL documents, DISCO documents, and WSIL documents for this web service. These documents are used by applications to understand the format of messages that may be sent to the various services. The /system/wsdlMap/@changeNumber (minOccurs=0 maxOccurs=1) changeNumber attribute is designed to facilitate caching of the element and its descendants. This attribute is assigned to this element by the .NET My Services system. The attribute is read-only to applications. Attempts to write this attribute are silently ignored.

The /system/wsdlMap/@id (minOccurs=0 maxOccurs=1) attribute is a globally unique ID assigned to this element by .NET My Services. Normally, .NET My Services will generate and assign this ID during an insertRequest operation, or possibly during a replaceRequest. Application software can override this ID generation by specifying the useClientIds attribute in the request message. Once an ID is assigned, the attribute is read-only and attempts to write it are silently ignored. The /system/wsdlMap/@creator (string minOccurs=0 maxOccurs=1) attribute identifies the creator in terms of userId, appId, and platformId of the node.

The /system/wsdlMap/wsdl (minOccurs=0 maxOccurs=unbounded) element is used to specify the location of a WSDL file for this service. Multiple entries may exist pointing to the same file hosted in multiple locations, or to variations on the content within the WSDL files.

The /system/wsdlMap/wsdl/@wsdlLocation (anyURI minOccurs=0 maxOccurs=1) attribute is a URI that specifies the location of the WSDL file. The /system/wsdlMap/wsdl/{any} (minOccurs=0 maxOccurs=unbounded) provides for extensibility.

The /system/wsdlMap/disco (minOccurs=0 maxOccurs=unbounded) element is used to specify the location of a DISCO (web-services discovery) file for this service. Multiple entries may exist pointing to the same file hosted in multiple locations, or to variations on the content within the DISCO files. The /system/wsdlMap/disco/@discoLocation (anyURI minOccurs=0 maxOccurs=1) attribute is a URI that specifies the location of the DISCO file. The /system/wsdlMap/disco/{any} (minOccurs=0 maxOccurs=unbounded) provides extensibility. The /system/wsdlMap/wsil (minOccurs=0 maxOccurs=unbounded) element is used to specify the location of a WSIL file for this service. Multiple entries may exist pointing to the same file hosted in multiple locations, or to variations on the content within the WSIL files. The /system/wsdIMap/wsil/@wsilLocation (anyURI minOccurs=0 maxOccurs=1) attribute is a URI that specifies the location of the WSIL file. The /system/wsdlMap/wsil/{any} (minOccurs=0 maxOccurs=unbounded) provides extensibility.

myInbox/Domian Specific Methods

The .NET Inbox service has seven domain-specific messages, including a myInbox /sendMessage method, which sends a plain-text or fully MIME-encoded message from the user's account. If the optional, “saveSentMessage” is included, a copy of the sent message will be saved in the Sent Messages folder and the responseBody will include a header element with the new system-defined ID attribute.

Another method is a myInbox/sendMessageRequest, which is accessed using a request message. In response, this method may generate a response message or a SOAP Fault message. The following sample document fragments generally set forth the structure and meaning of the elements and attributes in the request and response messages.

The following section describes the request message for this method:

<m:sendMessageRequest

xmlns:m=“http://schemas.microsoft.com/hs/2001/10/myInbox”
xmlns:hs=“http://schemas.microsoft.com/hs/2001/10/core”>_{1 1}
<m:draftMessage select=“...”>_{0 1}

<m:saveInFolder ref=“...”>_{0 1}</m:saveInFolder>

</m:draftMessage>
<m:rawMessage>_{0.1}

<m:messageStatus>_{0 1}

<m:saveInFolder ref=“...”>_{0 1}</m:saveInFolder>
<m:flag>_{0.1}

<m:state>_{1.1}</m:state>
<m:title xml:lang=“...” dir=“...”>_{1.1}</m:title>
<m:reminderDate>_{0 1}</m:reminderDate>
{any}

</m:flag>
{any}

</m:messageStatus>
<m:messageContent>_{0 1}

<m:cat ref=“...”>_{0. unbounded}</m:cat>
<m:raw2822Content>_{1 1}</m:raw2822Content>
{any}

</m:messageContent>

</m:rawMessage>

</m:sendMessageRequest>

The /sendMessageRequest (minOccurs=1 maxOccurs=1) method is used to send a message from myInbox. It takes a pointer to a draft message to send, or a raw message that represents a full RFC2822/Mime message. This method is accessed using a request message, and in response may generate a domain-specific response message, or may generate a SOAP fault message. The types used in these messages are fully specified in the service's schema document referenced above.

The sendMessageRequest/draftMessage (minOccurs=0 maxOccurs=1) element is used to identify an existing draft to send. The /sendMessageRequest/draftMessage/@select (string minOccurs=1 maxOccurs=1) item specifies an XPath expression that selects a set of nodes relative to the externally established context. The expression can never travel outside the node-set established by this externally established current context. The expression can match zero or more nodes, and the operation manipulates all selected nodes. The minOccurs and maxOccurs attributes are optional and place restrictions and limitations on the number of nodes selected.

The /sendMessageRequest/draftMessage/saveInFolder (minOccurs=0 maxOccurs=1) element defines the folder in which a copy of this message should be saved. The /sendMessageRequest/draftMessage/saveInFolder/@ref (minOccurs=0 maxOccurs=1) uuidType is used to specify a universally unique identifier (UUID).

The /sendMessageRequest/rawMessage (minOccurs=0 maxOccurs=1) element is used to specify a raw message to send.

The /sendMessageRequest/rawMessage/messageStatus (minOccurs=0 maxOccurs=1) includes a The /sendMessageRequest/rawMessage/messageStatus/saveInFolder (minOccurs=0 maxOccurs=1) element that defines the folder in which a copy of this message should be saved.

The /sendMessageRequest/rawMessage/messageStatus/saveInFolder/@ref (minOccurs=0 maxOccurs=1) uuidType is used to specify a universally unique identifier (UUID).

The /sendMessageRequest/rawMessage/messageStatus/flag (minOccurs=0 maxOccurs=1) optional element defines the flag state of the message. It includes an {any} element that can be used for extensible flags. The /sendMessageRequest/rawMessage/messageStatus/flag/state (string minOccurs=1 maxOccurs=1) field contains the state of a message flag. The /sendMessageRequest/rawMessage/messageStatus/flag/title (string minOccurs=1 maxOccurs=1) field contains the client defined text of the flag. The /sendMessageRequest/rawMessage/messageStatus/flag/title/@xml:lang (minOccurs=1 maxOccurs=1) required attribute is used to specify an ISO 639 language code or an ISO 3166 country code as described in RFC 1766. The value of this attribute indicates the language type of the content within this element. The /sendMessageRequest/rawMessage/messageStatus/flag/title/@dir (string minOccurs=0 maxOccurs=1) optional attribute specifies the default layout direction for the localized string. Valid values are rtl (right to left) and ltr (left to right).

The /sendMessageRequest/rawMessage/messageStatus/flag/reminderDate (dateTime minOccurs=0 maxOccurs=1) field contains the client-defined reminder date of the flag.

The /sendMessageRequest/rawMessage/messageStatus/flag/{any} (minOccurs=0 maxOccurs=unbounded), if present, includes the /sendMessageRequest/rawMessage/messageStatus/{any} (minOccurs=0 maxOccurs=unbounded) field, for extensibility. The /sendMessageRequest/rawMessage/messageContent (minOccurs=0 maxOccurs=1) field represents a complete RFC2822 /MIME message. The /sendMessageRequest/rawMessage/messageContent/cat (minOccurs=0 maxOccurs=unbounded) element is used to categorize the element that contains it by referencing either a global category definition (in either the .NET Categories service system document or an external resource containing category definitions), or by referencing an identity-centered category definition in the content document of the .NET Categories service for a particular PUID.

The /sendMessageRequest/rawMessage/messageContent/cat/@ref (anyURI minOccurs=1 maxOccurs=1) attribute references a category definition (catDef) element using the rules outlined in the .NET Categories section, above.

The /sendMessageRequest/rawMessage/messageContent/raw2822Content (base64Binary minOccurs=1 maxOccurs=1) field contains the complete RFC2822/MIME content. The /sendMessageRequest/rawMessage/messageContent/{any} (minOccurs=0 maxOccurs=unbounded) field provides for extensibility.

Upon successful completion of a message request, a response message is generated by the sendMessageResponse method. The format of the response message is described in the following table:

<m:sendMessageResponse selectedNodeCount=“...” status=“...”

xmlns:m=“http://schemas.microsoft.com/hs/2001/10/myInbox”
xmlns:hs=“http://schemas.microsoft.com/hs/2001/10/core”>_{1 1}
<m:newBlueId id=“...”>_{1. 1}</m:newBlueId>

</m:sendMessageResponse>

The /sendMessageResponse (minOccurs=1 maxOccurs=1) response is used to indicate the success of the operation as well as the new id associated with any messages that were saved as a result of this method. The /sendMessageResponse/@selectedNodeCount (int minOccurs=0 maxOccurs=1) attribute is used to return the number of selected nodes, selected by the corresponding data language operation.

The /sendMessageResponse/@status (string minOccurs=1 maxOccurs=1) attribute indicates the status of the method. If the status is success, the corresponding method was completed successfully. If the status is failure, the corresponding method was not completed successfully. If the status is rollback, the method failed, but was rolled back to its pre-updateBlock status. If the status is notAttempted, the corresponding method was not attempted. This occurs when a previous operation failed.

The /sendMessageResponse/newBlueId (minOccurs=1 maxOccurs=1) field contains the new identifier of the message that was saved in myInbox. The /sendMessageResponse/newBlueId/@id (minOccurs=1 maxOccurs=1) attribute specifies the ID of the deleted item.

If the method causes a failure response to be generated, the failure is noted by generation of a SOAP Fault message. Failures can include a failure to understand a header marked as “s:mustUnderstand”, a .NET My Services standard error, security violation, load-balance redirect, or any service-specific severe error condition.

The myInbox/saveMessage allows a client to add either a complete rfc822 local message to .NET Inbox or to save a draft message.

The myInbox/saveMessageRequest method is accessed using a request message, and in response may generate a response message or a SOAP Fault message. The following sample document fragments and description below illustrate the structure and meaning of the elements and attributes in the request and response messages:

<m:saveMessageRequest

xmlns:m=“http://schemas.microsoft.com/hs/2001/10/myInbox”
xmlns:hs=“http://schemas.microsoft.com/hs/2001/10/core”>_{1 1}
<m:completeLocalMessage>_{0.1}

<m:messageStatus>_{0. 1}

<m:isRead>_{1 1}</m:isRead>
<m:folder ref=“...”>_{1.1}</m:folder>
<m:flag>_{0..1}

<m:state>_{1 1}</m:state>
<m:title xml:lang=“...” dir=“...”>_{1 1}</m:title>
<m:reminderDate>_{0 1}</m:reminderDate>
{any}

</m:flag>
<m:state>_{1.1}</m:state>
{any}

</m:messageStatus>
<m:messageContent>_{0 1}

<m:cat ref=“...”>_{0 unbounded}</m:cat>
<m:raw2822Content>_{1..1}</m:raw2822Content>
{any}

</m:messageContent>

</m:completeLocalMessage>

</m:saveMessageReguest>

The /saveMessageRequest (minOccurs=1 maxOccurs=1) method is used to save a local message (for example in a PST file) into myInbox. This method is accessed using a request message, and in response may generate a domain-specific response message, or may generate a SOAP fault message. The types used in these messages are fully specified in the services base schema document referenced above.

The /saveMessageRequest/completeLocalMessage (minOccurs=0 maxOccurs=1) element represents a complete local message to add to myInbox. The /saveMessageRequest/completeLocalMessage/messageStatus (minOccurs=0 maxOccurs=1), if present, includes the /saveMessageRequest/completeLocalMessage/messageStatus/isRead (boolean minOccurs=1 maxOccurs=1) element, which defines the read/unread state of the message and can be modified.

The /saveMessageRequest/completeLocalMessage/messageStatus/folder (minOccurs=1 maxOccurs=1) element defines the single folder that this message logically belongs to. The /saveMessageRequest/completeLocalMessage/messageStatus/folder/@ref (minOccurs=0 maxOccurs=1) uuidType is used to specify a universally unique identifier (UUID). The /saveMessageRequest/completeLocalMessage/messageStatus/flag (minOccurs=0 maxOccurs=1) optional element defines the flag state of the message. It includes an {any} element that can be used for extensible flags.

The /saveMessageRequest/completeLocalMessage/messageStatus/flag/state (string minOccurs=1 maxOccurs=1) field contains the state of a message flag. The /saveMessageRequest/completeLocalMessage/messageStatus/flag/title (string minOccurs=1 maxOccurs=1) field contains the client-defined text of the flag. The /saveMessageRequest/completeLocalMessage/messageStatus/flag/title/@xml:lang (minOccurs=1 maxOccurs=1) required attribute is used to specify an ISO 639 language code or an ISO 3166 country code as described in RFC 1766. The value of this attribute indicates the language type of the content within this element. The /saveMessageRequest/completeLocalMessage/messageStatus/flag/title/@dir (string minOccurs=0 maxOccurs=1) optional attribute specifies the default layout direction for the localized string. Valid values are rtl (right to left) and ltr (left to right). The /saveMessageRequest/completeLocalMessage/messageStatusag/reminderDate (datetime minOccurs=0 maxOccurs=1) field contains the client-defined reminder date of the flag. The /saveMessageRequest/completeLocalMessage/messageStatus/flag/{any} (minOccurs=0 maxOccurs=unbounded) field provides extensibility, as described above.

The /saveMessageRequest/completeLocalMessage/messageStatus/state (string minOccurs=1 maxOccurs=1) element defines the sent/received state of the message. The /saveMessageRequest/completeLocalMessage/messageStatus/{any} (minOccurs=0 maxOccurs=unbounded) field provides for extensibility.

The /saveMessageRequest/completeLocalMessage/messageContent (minOccurs=0 maxOccurs=1) field represents a complete RFC2822/MIME message. The /saveMessageRequest/completeLocalMessage/messageContent/cat (minOccurs=0 maxOccurs=unbounded) element is used to categorize the element that contains it by referencing either a global category definition (in either the .NET Categories service system document or an external resource containing category definitions), or by referencing an identity-centered category definition in the content document of the .NET Categories service for a particular PUID.

The /saveMessageRequest/completeLocalMessage/messageContent/cat/@ref (anyURI minOccurs=1 maxOccurs=1) attribute references a category definition (catDef) element using the rules outlined in the .NET Categories (MyCategories) section, above. The /saveMessageRequest/completeLocalMessage/messageContent/raw2822Content (base64Binary minOccurs=1 maxOccurs=1) field contains the complete RFC2822 /MIME content. The /saveMessageRequest/completeLocalMessage/messageContent/{any} (minOccurs=0 maxOccurs=unbounded) field provides for extensibility.

Upon successful completion of this method, a response message is generated. The format of the response message, myInbox/saveMessageResponse, is described next. To this end, the document fragment in the table below and the various meanings are described:

<m:saveMessageResponse selectedNodeCount=“...” status=“...”

xmlns:m=“http://schemas.microsoft.com/hs/2001/10/myInbox”
xmlns:hs=“http://schemas.microsoft.com/hs/2001/10/core”>_{1 1}
<m:newBlueId id=“...”>_{1 1}</m:newBlueId>

</m:saveMessageResponse>

The /saveMessageResponse (minOccurs=1 maxOccurs=1) response contains a newBlueId for each message that was successfully saved. The /saveMessageResponse/@selectedNodeCount (int minOccurs=0 maxOccurs=1) attribute is used to return the number of selected nodes, selected by the corresponding data language operation. The /saveMessageResponse/@status (string minOccurs=1 maxOccurs=1) attribute indicates the status of the method. If the status is success, the corresponding method was completed successfully. If the status is failure, the corresponding method was not completed successfully. If the status is rollback, the method failed, but was rolled back to its pre-updateBlock status. If the status is notAttempted, the corresponding method was not attempted. This occurs when a previous operation failed.

The /saveMessageResponse/newBlueId (minOccurs=1 maxOccurs=1) element represents the new or saved message. The /saveMessageResponse/newBlueId/@id (minOccurs=1 maxOccurs=1) attribute specifies the ID of the deleted item.

If the method causes a failure response to be generated, the failure is noted by generation of a SOAP Fault message. Failures can include a failure to understand a header marked as “s:mustUnderstand”, a .NET My Services standard error, security violation, load-balance redirect, or any service-specific severe error condition.

The myInbox/copyMessage method allows clients to copy one or more messages into a folder. The message data, (including attachments) is copied and new message headers are returned with unique header ID values.

The myInbox/copyMessageRequest method is accessed using a request message, and in response may generate a response message or a SOAP Fault message. The following sample document fragments and following description illustrate the structure and meaning of the elements and attributes in the request and response messages:

<m:copyMessageRequest useClientIds=“...”

xmlns:m=“http://schemas.microsoft.com/hs/2001/10/myInbox”
xmlns:hs=“http://schemas.microsoft.com/hs/2001/10/core”>_{1 1}
<m:message select=“...” copyAsDraft=“...”
clientId=“...”>_{1 .unbounded}</m:message>
<m:targetFolder ref=“...”>_{1 1}</m:targetFolder>

</m:copyMessageReguest>

The /copyMessageRequest (minOccurs=1 maxOccurs=1) message allows clients to copy one or more messages to a folder. The message data (including attachments) is copied and new message messages are returned with unique message ID values. This element encapsulates the arguments to the copyMessage method. It contains a message element and a targetFolder element.

The /copyMessageRequest/@useClientIds (boolean minOccurs=0 maxOccurs=1) optional attribute, if present, specifies that each message element's id attribute will be used as the new id. The /copyMessageRequest/message (minOccurs=1 maxOccurs=unbounded) element contains a select statement that contains an XPATH expression indicating a message for which to copy the associated message.

The /copyMessageRequest/message/@select (string minOccurs=1 maxOccurs=1) field contains the location of the message (which is associated with the message) to copy, e.g., /myInbox/message[@id=“”].

The /copyMessageRequest/message/@copyAsDraft (boolean minOccurs=0 maxOccurs=1), if this value is present and set to true, causes the message to be copied as a draft into the target folder.

The /copyMessageRequest/message/@clientId (minOccurs=0 maxOccurs=1) attribute specifies that the server should use the value of this attribute as the id of the new message; useClientIds should be present on the copyRequest element and set to true The /copyMessageRequest/targetFolder (minOccurs=1 maxOccurs=1) field contains the id of an existing folder to copy the message(s) to.

The /copyMessageRequest/targetFolder/@ref (minOccurs=0 maxOccurs=1) uuidType is used to specify a universally unique identifier (UUID).

Upon successful completion of this method, a response message, myInbox/copyMessageResponse, is generated. The format of the response message is described next:

<m:copyMessageResponse selectedNodeCount=“...” status=“...”

xmlns:m=“http://schemas.microsoft.com/hs/2001/10/myInbox”
xmlns:hs=“http://schemas.microsoft.com/hs/2001/10/core”>_{1 1}
<m:newBlueId id=“...”>_{1 1}</m:newBlueId>

</m:copyMessageResponse>

The /copyMessageResponse (minOccurs=1 maxOccurs=1) response from copyMessage includes a newBlueId element for each successfully copied message. The /copyMessageResponse/@selectedNodeCount (int minOccurs=0 maxOccurs=1) attribute is used to return the number of selected nodes, selected by the corresponding data language operation.

The /copyMessageResponse/@status (string minOccurs=1 maxOccurs=1) attribute indicates the status of the method. If the status is success, the corresponding method was completed successfully. If the status is failure, the corresponding method was not completed successfully. If the status is rollback, the method failed, but was rolled back to its pre-updateBlock status. If the status is notAttempted, the corresponding method was not attempted. This occurs when a previous operation failed.

The /copyMessageResponse/newBlueId (minOccurs=1 maxOccurs=1) element is typically found in the body of an insertResponse, updateResponse, or replaceResponse to indicate that a new ID value was generated by the corresponding request operation. Applications, in response, need to walk through their changes in order, and apply the returned ID to any cached value of the node they just inserted. Only a new ID generation triggers this, so in the case of an ID-preserving replaceRequest, the root of the replacement never generates one of these, but an inner xdb:blue does.

The /copyMessageResponse/newBlueId/@id (minOccurs=1 maxOccurs=1) attribute specifies the ID of the deleted item.

If the method causes a failure response to be generated, the failure is noted by generation of a SOAP Fault message. Failures can include a failure to understand a header marked as “s:mustUnderstand”, a .NET My Services standard error, security violation, load-balance redirect, or any service-specific severe error condition.

As can be seen from the foregoing detailed description, there is provided a schema-based inbox service that allows users to access their data based on their identities and corresponding roles with respect to the data. The schema-based inbox service provides Inbox data access independent of the application program and device, and in a centrally-accessible location such as the Internet. The schema-based inbox service is extensible to handle extended contact information.

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

What is claimed is:

1. In a computer network, a method comprising,
providing an inbox schema, the inbox schema having inbox-related fields arranged into a content document with defined structures for the fields;
receiving a data access request directed to contact information, the request including associated identity information; and
in response to the data access request, manipulating at least one set of data in a logical inbox document that includes data therein according to the associated identity information, each set of data in the logical inbox document structured to correspond to a field in the content document.

2. The method of claim 1 wherein manipulating at least one set of data comprises reading data from at least one field in the logical inbox document.

3. The method of claim 1 wherein manipulating at least one set of data comprises writing data to at least one field in the logical inbox document.

4. In a computer network, a method comprising,
receiving a request to retrieve inbox data, the request including associated identity information;
reading from a data store to obtain inbox data based on the associated identity information;
constructing an inbox document including at least part of the data, the document arranged according to a defined schema for inbox data; and
returning the document in response to the request.

5. The method of claim 4 wherein the schema includes at least one defined field for extending the schema.
